SEQUENCE LISTING (9 sequences)

SEQ ID NO: 1 - DNA, 1836 bp, Glycine max
ttaacaatgaccaagatttatgctatatagaagacttggagggcttaaggctatgatatattatggatgatatggttctgatttgtgtagtttcgaaggatcaaatcaaccatttgttggtacaatgggaagaaaaaatgttttcatcattccactctattgaaaaagatccaacaattgtaacaccccgacgaatcacaccggaaagagaagaatccaaagattgtgtaggtatgagactgtatagttgatgaaaacttaaaaaaattaattggtactacttataccaacaagatgcatatatttttcgatagcctatcacataagaacttcatagttaagggtgcttaacttggagtagttatgaaatgagtgaccttttaaaataattattgtcttaggttattgtatgaaaataaaaaataataataaatatacataaaaaataataattttataaaattaaccttatattatcattaatttatttttagattttgttattcattattaatatatgaggtataaatgaaaaatataattaatgtcacattaaaaaattaaaatgataattattttgaaacaaattatttatttttatacgacaattataatagaaatttgagagtaaaaaaaaattgaaaattcataaaatatatgaatatattcatttctcctatccgtcaaataaatctgctccataatttatctaagcattggtcttgtagttcagagtaataaaattttagcaattattagttagtacagatacatttaaagaaataatatattttagcaactagaagtttataaaaagttttaaattataaagacttatatataaatttagtaaaactagatggatgtcccaagtaatttttatataactattctcgtacaacattaatgaaaatcttgtttctattatttatatgtatattattattttattttggaacaatatgggattaaaaactcttataaattaaatcttagaataagttttcctaacatgttttttttatggatgttttcctaacatgtttggttatcttagttttgctttaattttgtcggattatttttggactttattaggtaattttgataaaacttttagttgatgttagtagtttactcttacataatgatttgatattgaatgtgtataattggaaggcaataaatgaagatcaagcgtacaagagttcgccaatcaagaggatttgaagagagtaaaatattatgcgaagtcccatgtgaagaaaatccaaccattggaataaaaaataaagttttttctttggaattgctaatgctacagcacttattggtacttgtcctaaaaatgaaactctagctatatttagcacttgatattcatgaatcaaacttctctatgaaataaccgcggtgcgcatcggtgcctgttgatcccgcgcaagttgggatcttgaagcaagttccgctcatcactaagtcgcttagcatgtttgaccttctcggacaactccttcttctctttaattgatcaacagtcagcatcatcacaccaaaagttaggcccgaatagtttgaaattagaaagctcgcaattgaggtctacaggccaaattcgctcttagccgtacaatattactcaccggatcctaaccggtgtgatcatgggccgcgattaaaaatctcaattatatttggtctaatttagtttggtattgagtaaaacaaattcggcgccatgcccgggcaagcggccgcacaagtttgtacaaaaaagcaggctccgcggtgactgactgaaaagcttgtcgacctgcaggtcaacggatcaggata

SEQ ID NO: 2 - DNA, 1550 bp, Glycine max
gcacatagacacacacatcatctcattgatgcttggtaataattgtcattagattgtttttatgcatagatgcactcgaaatcagccaattttagacaagtatcaaacggatgtgacttcagtacattaaaaacgtccgcaatatgatattcattaattttatattatctaaaagagttaaaagagaaaaaagaaatatgacaatttttttctttcacatcttctaacctaaaagtatgactctatggaggctaagtttagaaaaagatacggatctagggtgtggaaacatcaatggtcaactccttttatatttcaatcaattgggttttgctttatctttacattttctccttttattttccacgtctattcaaatctacttgttagcgggtgattactcttttttcttttatagatgccaattatttctctcctatgtattaaattagagtatattgtcttgaaagtgacttagtattttagtttatagtctcttaaagaacgacaccttttattcttaactctctttatcaagttttaatttaaaattattttaaattaagtatgcatacatatcttaatatttttcttaattatttttaaattccctaaatttaatgttttcatacaatgtaagagatatacatattaattatatttaaagataaaacttactttcctgcaataaaataaagaaaaggacagtcatacaattatataattaatccagaatatttatagcttttaaacatttattttctatcaattaagtaataactttaaataaaattaagagtacttttttatactccaaagaatttatttattttcaacaaaatcgtctgactgtttcaattgatcattatcagcctagcataacctaaatttcattttcaaacataacttttggcaccaaatcacccggcattgcaaaaaagtcttttgcgatatgaccctccacgacgcagaaccactgttattcattaccatcacttttaatcctaatttcccatacacttaccctttccatgacatcttcaaagcctttattttgcttttcttgtttaagctgttttaacctaatttcatgcatataaacaaagagtaaagcaaaggcaaatatttgtacgtatagtttttagacagaaaaggaaagtaaattatagagataatgaagtttgctcttttaaattcgtcgtgatgttatccatcatatctaaatgcttattcctgtttttgtcttttttctcttttaccggagtttattttatataattaattaaagttagtagatctatattctttttcatagataatccatcttctttggaggcacatcgatcattaatcatagagttttgagaagcattatcactaaagcttcaattaattatatccaataaacggtattggtgtatgatgttatgatagcaaatagataatctaatctatacgagccacaaaaggggcatgaactctatctcgaagaaattggagatgaagggattgagattggcaccttgtgctattattgcccactaatcatt

SEQ ID NO: 3 - DNA, 10212 bp, Artificial Sequence
  Sequence of soybean event pDAB4468.04.16.1. Including the 5′ genomic flanking sequence, pDAB4468 T-strand insert, and 3′ genomic flanking sequence.
ctgtcgttggattcacagaacattgacgccagttttcacttcgttatctttgaattcattaaaatcgaatctctcacctatacccccccatttttctaatccatcataatcaaaattcataaatgaatcagttaccattaccataatacctttttgaaaatgagtttgaataatcagtatctttagaaaactaattaagaaattaaataaaaaatatttatcatgaagatgagtgtaagaaaaattatgaaaagtataactttatacatttctataaaattattttttcttttaatttcttaattaatatcctaagtaaatgagttaatatttatctttcaaaaattcttatagtcgccaattaattttcccatgcaatgacaacttgtccgtattctacgtggtaggttaggctacctgccgagacaaattgccttgagacaaattcaatagagaacccttccaagggaccattataaatagagaactttcattaaccgataagccacaccctttcaatcaaacacaaacacttgaagtactaagttagtgtgtttgagcaaattaactatggcttcgttttgttctagattgacaatttgtttggctctgtttgtcctcatatgggggagtgccaatgcacaactttctacaaacttttactaccattcatgtccaaacctcttctcctctgtgaaatccacagtgcaatctgccatatctaaggagacccgcatgggtgcttctctccttcgcttgttcttccacgattgctttgtcaatgtaatttatttgcaccttctcccacttacatacaaatatgctaagcttacatatagctcctctttctaccacttgcatgcatcatctaattttgtttgaaacaacacttgttccttttattatacacatcatctttgataaaattttgtcgtgtgcaacttttttttagtgtgttaatcagttctatgatgatactattagttaagaaattttaatgcacttaataaaccattttaagtactttaaccgttcaatgatattatatatttaaagataataaatatttctgcttttgtttctatattagtgtagttaagaaccttcttacttcttagctagctaaatattaatgagtaaacattaacaaatgcagggatgtgatggttcaattctattggatgacacatcaagcttcaccggagagaagaacgcaaaccccaacaggaactctgctcgtggattcgaggttattgacaacattaaatcagccgtggagaaagtgtgtccaggagttgtttcctgcgcagatatccttgccatcgctgccagagactctgttcagattgtaagtggtcaaacaaccaacaaaaacacattaaactaaatcattaaattgtacatatcaaaattaattaccaatttagtaccacacatgcaattaaagagaacattttgttgattttgatcaatatagcttggaggccctacatggaatgttaaacttggaagaagagacgctagaactgctagccaatctgctgctaacaatggcatccctgcacccacttcaaaccttaaccaactcatctcaagatttagcgctcttggactttccaccaaggacttggtcgccttgtccggtacaaaacatatatcacataattttccaattaattacatttcaatcatatagtaaaatttctcaattaattaggaacatgagaaacttatagtcacacgttcttttgttgaggaatattgcatggtttaattttgctttcattaggtggtcacacaattggacaagcaaggtgcacaaacttcagagcccgcatctacaacgagaccaacatagaaaccgcatttgcaaggactaggcagcaaagctgccctagaacatcagggtcaggggacaacaatctggcaccacttgatcttcaaactccaaccagctttgacaactactacttcaagaacctcgttcagaagaagggtctcctccactctgatcagcaactgttcaacggtgggtccaccgactccattgtgcgtggctacagcaccaacccgggcaccttctcctctgatttcgccgccgccatgatcaagatgggagacattagtcctctcactggctccaatggagaaatcaggaagaattgtagaaggattaactaatttgattcagtcttgaatattaagggtcctacacatacgcaagcaatttaattgtgtttaataagttgttaaaacatgttttggttgtattttggattcctagtgtagtttcggtgatcaatgccgtctactttagtgtgttctacttccctttatttttgtttcttttttactttttccttaactatattgtaggaaaaaaaaaatcctttatcaagcatttatcaagaacggagtttgctttttaattttcccttcataacattccatcagaattcagttttgcttttgcttctaaattacgttcaaatcagggatgataatcggttaggtaatatatacagtaccccttgcatagtcacgtttgaaaaatataatcatacttagttcggtaacaatttaaattatcattctcgtaatcattagctacttatgcactcatatccgtatccgctacttgctcttgtcgtaagtcaataaattaatataaaaaaatacttaaaacttgttacaactaaattaaaaatttatttttaaatcattcaagcaccagtcagcatcatcacaccaaaagttaggcccgaatagtttgaaattagaaagctcgcaattgaggtctacaggccaaattcgctcttagccgtacaatattactcaccggatcctaaccggtgtgatcatgggccgcgattaaaaatctcaattatatttggtctaatttagtttggtattgagtaaaacaaattcgaaccaaaccaaaatataaatatatagtttttatatatatgcctttaagactttttatagaattttctttaaaaaatatctagaaatatttgcgactcttctggcatgtaatatttcgttaaatatgaagtgctccatttttattaactttaaataattggttgtacgatcactttcttatcaagtgttactaaaatgcgtcaatctctttgttcttccatattcatatgtcaaaacctatcaaaattcttatatatctttttcgaatttgaagtgaaatttcgataatttaaaattaaatagaacatatcattatttaggtatcatattgatttttatacttaattactaaatttggttaactttgaaagtgtacatcaacgaaaaattagtcaaacgactaaaataaataaatatcatgtgttattaagaaaattctcctataagaatattttaatagatcatatgtttgtaaaaaaaattaatttttactaacacatatatttacttatcaaaaatttgacaaagtaagattaaaataatattcatctaacaaaaaaaaaaccagaaaatgctgaaaacccggcaaaaccgaaccaatccaaaccgatatagttggtttggtttgattttgatataaaccgaaccaactcggtccatttgcacccctaatcataatagctttaatatttcaagatattattaagttaacgttgtcaatatcctggaaattttgcaaaatgaatcaagcctatatggctgtaatatgaatttaaaagcagctcgatgtggtggtaatatgtaatttacttgattctaaaaaaatatcccaagtattaataatttctgctaggaagaaggttagctacgatttacagcaaagccagaatacaatgaaccataaagtgattgaagctcgaaatatacgaaggaacaaatatttttaaaaaaatacgcaatgacttggaacaaaagaaagtgatatattttttgttcttaaacaagcatcccctctaaagaatggcagttttcctttgcatgtaactattatgctcccttcgttacaaaaattttggactactattgggaacttcttctgaaaatagtggccaccgcttaattaaggcgcgccatgcccgggcaagcggccgcacaagtttgtacaaaaaagcaggctccgcggtgactgactgaaaagcttgtcgacctgcaggtcaacggatcaggatattcttgtttaagatgttgaactctatggaggtttgtatgaactgatgatctaggaccggataagttcccttcttcatagcgaacttattcaaagaatgttttgtgtatcattcttgttacattgttattaatgaaaaaatattattggtcattggactgaacacgagtgttaaatatggaccaggccccaaataagatccattgatatatgaattaaataacaagaataaatcgagtcaccaaaccacttgccttttttaacgagacttgttcaccaacttgatacaaaagtcattatcctatgcaaatcaataatcatacaaaaatatccaataacactaaaaaattaaaagaaatggataatttcacaatatgttatacgataaagaagttacttttccaagaaattcactgattttataagcccacttgcattagataaatggcaaaaaaaaacaaaaaggaaaagaaataaagcacgaagaattctagaaaatacgaaatacgcttcaatgcagtgggacccacggttcaattattgccaattttcagctccaccgtatatttaaaaaataaaacgataatgctaaaaaaatataaatcgtaacgatcgttaaatctcaacggctggatcttatgacgaccgttagaaattgtggttgtcgacgagtcagtaataaacggcgtcaaagtggttgcagccggcacacacgagtcgtgtttatcaactcaaagcacaaatacttttcctcaacctaaaaataaggcaattagccaaaaacaactttgcgtgtaaacaacgctcaatacacgtgtcattttattattagctattgcttcaccgccttagctttctcgtgacctagtcgtcctcgtcttttcttcttcttcttctataaaacaatacccaaagcttcttcttcacaattcagatttcaatttctcaaaatcttaaaaactttctctcaattctctctaccgtgatcaaggtaaatttctgtgttccttattctctcaaaatcttcgattttgttttcgttcgatcccaatttcgtatatgttctttggtttagattctgttaatcttagatcgaagacgattttctgggtttgatcgttagatatcatcttaattctcgattagggtttcataaatatcatccgatttgttcaaataatttgagttttgtcgaataattactcttcgatttgtgatttctatctagatctggtgttagtttctagtttgtgcgatcgaatttgtcgattaatctgagtttttctgattaacagagatctccatggctcagaccactctccaaatcacacccactggtgccaccttgggtgccacagtcactggtgttcaccttgccacacttgacgatgctggtttcgctgccctccatgcagcctggcttcaacatgcactcttgatcttccctgggcaacacctcagcaatgaccaacagattacctttgctaaacgctttggagcaattgagaggattggcggaggtgacattgttgccatatccaatgtcaaggcagatggcacagtgcgccagcactctcctgctgagtgggatgacatgatgaaggtcattgtgggcaacatggcctggcacgccgactcaacctacatgccagtcatggctcaaggagctgtgttcagcgcagaagttgtcccagcagttgggggcagaacctgctttgctgacatgagggcagcctacgatgcccttgatgaggcaacccgtgctcttgttcaccaaaggtctgctcgtcactcccttgtgtattctcagagcaagttgggacatgtccaacaggccgggtcagcctacataggttatggcatggacaccactgcaactcctctcagaccattggtcaaggtgcatcctgagactggaaggcccagcctcttgatcggccgccatgcccatgccatccctggcatggatgcagctgaatcagagcgcttccttgaaggacttgttgactgggcctgccaggctcccagagtccatgctcaccaatgggctgctggagatgtggttgtgtgggacaaccgctgtttgctccaccgtgctgagccctgggatttcaagttgccacgtgtgatgtggcactccagactcgctggacgcccagaaactgagggtgctgccttggtttgagtagttagcttaatcacctagagctcggtcaccagcataatttttattaatgtactaaattactgttttgttaaatgcaattttgctttctcgggattttaatatcaaaatctatttagaaatacacaatattttgttgcaggcttgctggagaatcgatctgctatcataaaaattacaaaaaaattttatttgcctcaattattttaggattggtattaaggacgcttaaattatttgtcgggtcactacgcatcattgtgattgagaagatcagcgatacgaaatattcgtagtactatcgataatttatttgaaaattcataagaaaagcaaacgttacatgaattgatgaaacaatacaaagacagataaagccacgcacatttaggatattggccgagattactgaatattgagtaagatcacggaatttctgacaggagcatgtcttcaattcagcccaaatggcagttgaaatactcaaaccgccccatatgcaggagcggatcattcattgtttgtttggttgcctttgccaacatgggagtccaaggttgcggccgcgcgccgacccagctttcttgtacaaagtggttgcggccgcttaattaaatttaaatgcccgggcgtttaaacgcggccgcttaattaaggccggcctgcagcaaacccagaaggtaattatccaagatgtagcatcaagaatccaatgtttacgggaaaaactatggaagtattatgtaagctcagcaagaagcagatcaatatgcggcacatatgcaacctatgttcaaaaatgaagaatgtacagatacaagatcctatactgccagaatacgaagaagaatacgtagaaattgaaaaagaagaaccaggcgaagaaaagaatcttgaagacgtaagcactgacgacaacaatgaaaagaagaagataaggtcggtgattgtgaaagagacatagaggacacatgtaaggtggaaaatgtaagggcggaaagtaaccttatcacaaaggaatcttatcccccactacttatccttttatatttttccgtgtcatttttgcccttgagttttcctatataaggaaccaagttcggcatttgtgaaaacaagaaaaaatttggtgtaagctattttctttgaagtactgaggatacaacttcagagaaatttgtaagtttgtagatctccatgtctccggagaggagaccagttgagattaggccagctacagcagctgatatggccgcggtttgtgatatcgttaaccattacattgagacgtctacagtgaactttaggacagagccacaaacaccacaagagtggattgatgatctagagaggttgcaagatagatacccttggttggttgctgaggttgagggtgttgtggctggtattgcttacgctgggccctggaaggctaggaacgcttacgattggacagttgagagtactgtttacgtgtcacataggcatcaaaggttgggcctaggatccacattgtacacacatttgcttaagtctatggaggcgcaaggttttaagtctgtggttgctgttataggccttccaaacgatccatctgttaggttgcatgaggctttgggatacacagcccggggtacattgcgcgcagctggatacaagcatggtggatggcatgatgttggtttttggcaaagggattttgagttgccagctcctccaaggccagttaggccagttacccagatctgaggtaccctgagcttgagcttatgagcttatgagcttagagctcggatccactagtaacggccgccagtgtgctggaattcgcccttgactagataggcgcccagatcggcggcaatagcttcttagcgccatcccgggttgatcctatctgtgttgaaatagttgcggtgggcaaggctctctttcagaaagacaggcggccaaaggaacccaaggtgaggtgggctatggctctcagttccttgtggaagcgcttggtctaaggtgcagaggtgttagcgggatgaagcaaaagtgtccgattgtaacaagatatgttgatcctacgtaaggatattaaagtatgtattcatcactaatataatcagtgtattccaatatgtactacgatttccaatgtctttattgtcgccgtatgtaatcggcgtcacaaaataatccccggtgactttcttttaatccaggatgaaataatatgttattataatttttgcgatttggtccgttataggaattgaagtgtgcttgcggtcgccaccactcccatttcataattttacatgtatttgaaaaataaaaatttatggtattcaatttaaacacgtatacttgtaaagaatgatatcttgaaagaaatatagtttaaatatttattgataaaataacaagtcaggtattatagtccaagcaaaaacataaatttattgatgcaagtttaaattcagaaatatttcaataactgattatatcagctggtacattgccgtagatgaaagactgagtgcgatattatggtgtaatacatagcggccgggtttctagtcaccggttaggatccgtttaaactcgaggctagcgcatgcacatagacacacacatcatctcattgatgcttggtaataattgtcattagattgtttttatgcatagatgcactcgaaatcagccaattttagacaagtatcaaacggatgtgacttcagtacattaaaaacgtccgcaatgtgttattaagttgtctaagcgtcaatattttaattcttaacaatcaatattttaattcttaaactttattaaatctaacaataaactgtaagaactaattcttaaacttcaataaacaatactgcgttttagtaattaaattaataatatatagatatagatatataatttgtcaacatattcttacctatttttccattgaaatatgttagcaagttcaaaaaaagttttgacaaaaaactctactatcttttgtttcatttactttatgtgagggatataatagtaatataacatttagtttatttaaagaaaataaaaaagttaatttctctttctgccactgatactctatggtggagagatccgatgcagtggtggagcctggcctcgacacataagtgtgacgacgcagctgttgaagagatctgattcgacggtggggtaatgcatggtggttgacaggttgatgggtggagaagacgtaattgctaccgccgtcaacggaggaaggagcaaagatgtctcgtatgtgaaaattatgcggttgagatgccgtttcattccctttaaaaaaatcccttgatggttgcaatgcaaattaaaaattgaaaaaataattaattgttcaaattaaagatttagcatgaaaaaaaaaacacttaattgtgcccatgactccatgacctgcgtaacttgggaaggaaaggaatttttttgctaaaggaaggcatgggaagatgagagaggagagagaatcagtggaagtgagagaaattaactttttgttttttaaaaactaaatattatattactattatatatatatatatatatatataaaagattttttagctggattcttgatataaaaaatttctcaccatatttattattatatatttttttggagatctcaaaaaaggaagttggatttcttctcaataactctaaaaaattattcctatttcaaaaaatattttttatgtctttctctaattgatgaataatatctatttaagtatattttattgtgaaatccacaaaagtgactgataaatctaatttaggatctaccattagagaaaaataaataaattcttatattatatgtgat

SEQ ID NO: 4 - DNA, 20 bp, Artificial sequence
  5′ Junction Sequence
ttagtgtgtgtgtcaaacac

SEQ ID NO: 5 - DNA, 20 bp, Artificial sequence
  3′ Junction sequence
atgaagccatcaaaaagtag

SEQ ID NO: 6 - DNA, 6285 bp, Artificial sequence
  5′ Flanking Sequence Plus Junction
gggaaaatccctcttccatattaagaacataaaaatcaacaggaaaaataagttcaccaacccgaaccagcacatcctctatgaaacctgcggggtaagcagcacttctattttccaaatgaatcaccacatctgtagattgcaaaggtccaagagataaagaattgaaaatggacagaggggtgacactaactgatgctcctagatctagcattgtattatcaaatttactgttcccaataatgcaaggtatacagaaagtacctgggtccttacatttctcaggaatgtaaggaacaaatttacctatcaatgctgacacatttctgcccatgctaatcctttcattgcctttgagcttccttttgtgggtgcacaactcctttagaaacttgacacatcttggaatctgcttgatggcatctagcagaggtatgttcacctctactttcctgaaggtctccaagatctccttttctgcttcttccattttttttgtttggaattgctcaaggttggaatggaagagggataagaggctgcggtaagtcagaattactagaagaaggtccacctgcatgaaaatttttgttaggaagctttctcttttgtgcaactatctcatcctctttttcaggtgtagaatgaagcttgacaggttcaggtgcgggtgctgctactggtggaggtacttgaatttggttgtcagacctcaaggtgatgacactcacatttttcggattttgcacagtttgtgaaggcaatttgtcagaattttgggaatgagcttggttcaactgagtagccatccgccccatctgatttgtcagactctgaatgaaggctcttgtctcttgctgaaattgcatattctggatggtcatttgcctcactaactcttctaaggaaggttaaggaggagtctcagttgcttgttgtctttgttgtgactgttgttgttgttgctgctgtattggaggaggaacatatggtttgcttggaccagcaacattctggaaaggagggacagactgttgttgttgtgaaggacttgcccatctcatatttggatgatttctccaacctggattgtatctgttgcttggaagatcataattattttgctattgttggttttgctgttgagggggtctattataaatgtttgcagcataagcttcaggttgttcattgactccagattactgcaaagaaggacaaagatctgtatggtgatctgcagaagaacatataccacagactcttgtaacaggtgcaaatttctgattcatggcaagctgagttactaggttgaccaaggcatcaagttttccctcaagctttttattttcagtagataaagatgaatctgtggccacctcatcgactcctctaaggacaatagcatcatttcttgcactgaattgttgggagttggaagccttcttctcaatcaaattcctagcctcagcaggggtcatatcacgaagagctccaccactggcagcatcaatcatactcctctccatgttgctaagtccctcatagaaatattgaagaaggagttgctcagaaatctggtggtgaggacagcttgcacacaatttcttgaatctttctcagtactcatacaagctctctccactaagttgcctgatgcctgaaatttcttttctgatggcagtggtcctagatgcagggaagaatttctccaagaacaccctcttaaggtcatcccagctgaaaatggacctgggagcaaggtagtagagccaatcttttgtcactacctccagagaatgaggaaaagcctttagaaagatatgatcttcttggacatcagggggcttcatggtggaacaaacaatatggaactccttaagatgcttatgaggatcttcacctagaagaccatgaaacttgggtagcaaatgtattagtccagtcttgagaacatatggaacaccctcatcaggatattgaatgcacaagttttcataagtgaaatcaggtgcagccatctccctaagagtcctctcacgaggtggaggtttagccatgttctcagtatgaaaattagtagttgaatgctcaaaatcagaatattcagaatcaccagaaacaaaatactcagaatgctcaaaatgctcaaaatgcacataatgattaggatgcacactatgcctaactaatctatgaaaggttctatctatttcaggatcgaagggttataaatcacctagattgcccctagtcatgcactatatgtagcaaataatgtgttctcaaacaagcaccaagggagggttaaaactacaactatagtcaaatgatatccaaatgagttgaaattttgtgagcagcaccctaaaatcatgaaaagatagcacaaaaaatttcaaacgaaaattcaaagtctaactatgaaaactacttaagaaaagtttagaaaaataggacaataatacttgaaaaataaaaaaaaacatagtaaacagctgatttttcgagtttgggagactccaaccggctaaaacgggttgccacaatatgagaaatttttttctaccccaaatgccacaatatgagaaagttttgctaaaatctagttcccaaaatttttgtctctctcaaattcaaccacaccaagtgctcctagtatttttcacacaaaaaatcagccaaaaataacaactctaactatcaaaacaaaaacagctaattaaattgcaaaatcagtcgctaattcctagtcactaatcactgttcacagcaaaacaccaactgaatcagtcgctaaacagtcgctaaacaggagacgcaactgaaatgcaaaacagaatgctacacaaaacaaaacaactaaacactattatgaacctttggcccactgctccccgacaacggcgccaaatttgatcgaggtcgtacccgaatcaaataaacattaaaaatgcagtatctaggaagtgatcctaggtcatctcccaacgagcaatggtcaaccaatgttcataatagatagtgataaaacaataacgaattggggggggggggtatttgtttttgtaatttaaacaacaagcaaattttaattagaaaataacagaattaaaacatgttatttccccttgattcataagcaagtctcttatcctaggttaggaggatttatccctaaccagttcaaccacttaatccaaccctaaattaaattactaagcgaaaattaacataaggttgtctttatatgattaagcaacacatacaccaattaatcatgaacaaaatcgatcattaagcatcaacataaattaagcgcaaagataattaatcaagcactaagcatgcatggattagtagcaacaaatacagagtaattggtggagatgaaaaactgatcaatattcaatagtaataacaaaacctcaaagagagttgtgcttgattctcaagagaaaacaacgctggagacttagccttccattaatcagtagaaaacgaaattgtagaaaacgaattttattctatgtgaacaatgtgcatgaacagtaataaaaactggaattgcaaaaccctaaaattattcttctctccaaaaaaactccctaaactaaaaccctggtgctattatataggtcctcagccccaaagcttacaaatctattttcagtccaaacccataaacgaaataaaataaaatctggacaagataagataagattggatgaaataaaatctggacgaaataaaatctggataagataagatttgataaaataaaattgtctgctcttttcaagtccaagcccaattccggattcaagcccaattttttataattcttctgaaattaaattaaaaatacgaaattagtcaagtaggcccaaatgataaaactgcataattaatttgacaattaaggctaatcagtaattaaaatagtgacaaaaagggttaagaaataggagaataatgacacatcacccatatggggagcaattctaaaatgcatttgagttctttaacctgagacacagtgcagtagagtctccaaggattcattgtgccttttattttatatgatggggtcactacattggccttgtcaaagaaactgaatttgggggattaaagaaacacaaaataaaaacaaatgaaactagttaatagaaatgttgcctattgcttcttggaaaaagtccaaccatttgtgatttggataaaattcatattacccacttgtagcttgttcaatcaaacactagatttggataaaatctcactcctagatatacctcaagggataatatgaccaacattagtcatttttagaaagtaaagtggacaaatttgagatttcattccttaatgacattataaacatgtattttttccatgaccctttttcaatgtaagtacaatttatcccttagtttagatactctatatatgcatgttacgtagttgatgaaaacatacctaagttgttgtgtatggttaagtttgcgactacctctgatatcaaactcctcatctccaatctcatacaaaagatacttgtcacttggtacctgaaccttgtcagtttgcagttgtgagtttcttctgaagccacacgcttgtatagtaaccagaagccaggagggagtcctctaaggctctaactcgtattttccgtggaagtacattttttttcttaaagaaaacagagatagtttaccaatgataatatttctttagccaaataggaccatcatagaaaacaaaactcttcttctaagtatttaatgcaactacatatttagggtgcgtttgattcgctaaaaaataagggtctagacaacacaaaaatatttttccaacgtttgattttaaaaatggctgagagacaatacaaaataaagaatgatgaactggacaaaaacctaaaaacttgtaactcactgaatctcatacaactttttgttcagtgtctaaaaaaagtaaaaatacaatattattcctattttttactttgattatctcacaccttctttctactcatttgtttcacttcacctctccagtgggcaccttggtttgtcggcgagagtcgtatggacttttgttgtttcctttttgctcattatttctttcttttcattgttaatttattcaaatgttcccatcatcatcttactccttcttgttatgttttttttctttggccaactccaacgaggccgtgccgcgaccaccatcatcacgaccttatggcggcctcacgccgcaaggccctgcacccagtggcatcaggggtcatgcctccttcttaaaggtgtctctcttttgttatgtcgtcaaagtgttgctaattcacctagaatttttcaatgaatccctttacttgtgggttagtctaggtcgctctgcccggttccaaccctagcccaaaaaaaaatgaaatgggtaggaaaggcgggcctagtttgaattaaaataaatcatgctaagatattgataactgctatgtataggtatattttgggattaaattatataggaattagtaatttttctctcttatttcttcctttttgttcaaataattggaattctaacatcatttaagtttttatgtagaaaatattaaaagttgatgaatttatgatacttagtgaataattagagtagaaaaataaagtaaagcccaaaaaagaaaattggtgatatgaagatacatgcttagcatgccccaggcacgcttagtgtgtgtgtcaaacactgatagtttaaactgaaggcgggaaacgacaatctgatccccatcaagcttgatatcgaattcctgcagcccgggggatccactagttctagagcggccgcgttaactgcaggtcgacggatccccgggtaccgagctcgaattcaaatttattatgtgttttttttccgtggtcgagattgtgtattattctttagttattacaagacttttagctaaaatttgaaagaatttactttaagaaaatcttaacatctgagataatttcagcaatagattatatttttcattactctagcagtatttttgcagatcaatcgcaacatatatggttgttagaaaaaatgcactatatatatatatattattttttcaattaaaagtgcatgatatataatatatatatatatatatatgtgtgtgtgtatatggtcaaagaaattcttatacaaatatacacgaacacatatatttgacaaaatcaaagtattacactaaacaatgagttggtgcatggc

SEQ ID NO: 7 - DNA, 2611 bp, Artificial sequence
  3′ Flanking Sequence Plus Junction
gactgacaagatcgatctgaagtctaaacaattctaagaggtatcatgtagcaatgtcctgccacaatattgaattgacctgcagcccgggcggccgcatcgatcgtgaagtttctcatctaagcccccatttggacgtgaatgtagacacgtcgaaataaagatttccgaattagaataatttgtttattgctttcgcctataaatacgacggatcgtaatttgtcgttttatcaaaatgtactttcattttataataacgctgcggacatctacatttttgaattgaaaaaaaattggtaattactctttctttttctccatattgaccatcatactcattgctgatccatgtagatttcccggacatgaagccatcaaaaagtaggactaatttaggaaagcaagctaattcaagaaagtgaaggcacgcttagtgtgagacacgtgttgagcgcgattactgccactcactaaccacacaagtgcactcagtgcgaaggttgcttaaaaattaagttgattcgcacttataaaagaaggatagagatgaaggaaaaaacacagaaaatacaattccttatagaagacaaaggctagaagaagcaaacgcaaacattagaagtcattccttccctcaattccctttttcaatttccccttttactaaatattctcctcttgcaattataaagcctcctatgacaatgacaagctaaactctcctttgttgggaacttatcagtcaactgctcttaatataatttctcttcctatctattatgaatattcactacaagaaatatgcccatttgccagggatttttgacagggacattaacccctggcaaatttcccagggactaagccaaggaaacccctggcaaaatgacatttgagaaggctgggaccacttacatttacacaggggtttgtccctcgcaaaaatacaaaagccttggcaaaaaaaagagcgggaaatgaattttaaaacagcatgttgttttcacacagccaaacacacgggtatgccctcgttttctgtaaagctgacggaatcttcccataagtcaacacgacatgaccatgcactgcaaaaagctgtgcggcccagacgtgacaggggtgttacccctcggaaatggcttgcagcccctggcaaaaaggaatccctgctttcctagctacaccgttctgctcatatagctgaagctaggaggttagcctttgactctgttgttttgcgaggggcattccgtgagttattccctgggtttttttacactatatagccaaaccgcgtgtttatcctcatgctcagtgttgtgtttttgaaacttagaaaaattttcggtttccatttccatcctcaccagttcattttcagtccattatcattcagttcatacacttgttctataatttggtaacactcttttcacttattatatttttctgtttttatttgttactacttattaacataaatattttttattgtatcagtgtccaaatttgcctcctcctgctgctccttgctctctgaatttgttctcttaagcttcaacaagttagtaatttttctacttataattttagatatatgatgtttatatatatgatgttataattttgcatgatctgtcaaagaaaatatgatgtttctacttgcatgatgtgttataatatatgatgtttatatatatttcgaattttgttgttaataaaactgtttaattagaaactgtataatttttttgtttaataaaactgtttaattttgcatgatctgtttaataaaactgtttatataaaactgtttatatataatatatgatgttaacatttttaaaactgtttataaaacagtttagttagaaaaaatgttaaaactagagaaaaaaatgtataataaaactgtgtcagtacagcagcgcgtcagaaaagtgtgcagatgcgtcagtgagaagacaggggctaagacagggattttgacagggaattttgccagggattttgccagggtcagcccctcgtttttttgccaggggtgaaatccctggcaaactgatttgcgatgggcgtttttcccagggattcagcccctggcaaaatccctggcaaacgtccatttcccagggctttttgttcttttcccagggaatccgcccctggcaaacgagcttgtttcttgtagtgattacttttgcattagtttttcctgtatttaattttattgtttatggcttgattacccatttgcattataagttttaggggtagcgttgaaaagtgttattctctaatagaactggaaaagagtatttaaataacttcatcactagggatacattgattttatttagcttattatatatctctattattaatgtaatttaactattttatctctgcaaagtgatttgggagagaagatagataagttagactctttcactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgaaggg

SEQ ID NO: 8 - DNA, 6426 bp, Artificial sequence
  Inserted DNA Sequence
tgtcaaacactgatagtttaaactgaaggcgggaaacgacaatctgatccccatcaagcttgatatcgaattcctgcagcccgggggatccactagttctagagcggccgcgttaactgcaggtcgacggatccccgggtaccgagctcgaattcaaatttattatgtgttttttttccgtggtcgagattgtgtattattctttagttattacaagacttttagctaaaatttgaaagaatttactttaagaaaatcttaacatctgagataatttcagcaatagattatatttttcattactctagcagtatttttgcagatcaatcgcaacatatatggttgttagaaaaaatgcactatatatatatatattattttttcaattaaaagtgcatgatatataatatatatatatatatatatgtgtgtgtgtatatggtcaaagaaattcttatacaaatatacacgaacacatatatttgacaaaatcaaagtattacactaaacaatgagttggtgcatggccaaaacaaatatgtagattaaaaattccagcctccaaaaaaaaatccaagtgttgtaaagcattatatatatatagtagatcccaaatttttgtacaattccacactgatcgaatttttaaagttgaatatctgacgtaggatttttttaatgtcttacctgaccatttactaataacattcatacgttttcatttgaaatatcctctataattatattgaatttggcacataataagaaacctaattggtgatttattttactagtaaatttctggtgatgggctttctactagaaagctctcggaaaatcttggaccaaatccatattccatgacttcgattgttaaccctattagttttcacaaacatactatcaatatcattgcaacggaaaaggtacaagtaaaacattcaatccgatagggaagtgatgtaggaggttgggaagacaggcccagaaagagatttatctgacttgttttgtgtatagttttcaatgttcataaaggaagatggagacttgagaagttttttttggactttgtttagctttgttgggcgtttttttttttgatcaataactttgttgggcttatgatttgtaatattttcgtggactctttagtttatttagacgtgctaactttgttgggcttatgacttgttgtaacatattgtaacagatgacttgatgtgcgactaatctttacacattaaacatagttctgttttttgaaagttcttattttcatttttatttgaatgttatatatttttctatatttataattctagtaaaaggcaaattttgcttttaaatgaaaaaaatatatattccacagtttcacctaatcttatgcatttagcagtacaaattcaaaaatttcccatttttattcatgaatcataccattatatattaactaaatccaaggtaaaaaaaaggtatgaaagctctatagtaagtaaaatataaattccccataaggaaagggccaagtccaccaggcaagtaaaatgagcaagcaccactccaccatcacacaatttcactcatagataacgataagattcatggaattatcttccacgtggcattattccagcggttcaagccgataagggtctcaacacctctccttaggcctttgtggccgttaccaagtaaaattaacctcacacatatccacactcaaaatccaacggtgtagatcctagtccacttgaatctcatgtatcctagaccctccgatcactccaaagcttgttctcattgttgttatcattatatatagatgaccaaagcactagaccaaacctcagtcacacaaagagtaaagaagaacaatggcttcctctatgctctcttccgctactatggttgcctctccggctcaggccactatggtcgctcctttcaacggacttaagtcctccgctgccttcccagccacccgcaaggctaacaacgacattacttccatcacaagcaacggcggaagagttaactgcatgcaggtgtggcctccgattggaaagaagaagtttgagactctctcttaccttcctgaccttaccgattccggtggtcgcgtcaactgcatgcaggccatggacaacaacccaaacatcaacgaatgcattccatacaactgcttgagtaacccagaagttgaagtacttggtggagaacgcattgaaaccggttacactcccatcgacatctccttgtccttgacacagtttctgctcagcgagttcgtgccaggtgctgggttcgttctcggactagttgacatcatctggggtatctttggtccatctcaatgggatgcattcctggtgcaaattgagcagttgatcaaccagaggatcgaagagttcgccaggaaccaggccatctctaggttggaaggattgagcaatctctaccaaatctatgcagagagcttcagagagtgggaagccgatcctactaacccagctctccgcgaggaaatgcgtattcaattcaacgacatgaacagcgccttgaccacagctatcccattgttcgcagtccagaactaccaagttcctctcttgtccgtgtacgttcaagcagctaatcttcacctcagcgtgcttcgagacgttagcgtgtttgggcaaaggtggggattcgatgctgcaaccatcaatagccgttacaacgaccttactaggctgattggaaactacaccgaccacgctgttcgttggtacaacactggcttggagcgtgtctggggtcctgattctagagattggattagatacaaccagttcaggagagaattgaccctcacagttttggacattgtgtctctcttcccgaactatgactccagaacctaccctatccgtacagtgtcccaacttaccagagaaatctatactaacccagttcttgagaacttcgacggtagcttccgtggttctgcccaaggtatcgaaggctccatcaggagcccacacttgatggacatcttgaacagcataactatctacaccgatgctcacagaggagagtattactggtctggacaccagatcatggcctctccagttggattcagcgggcccgagtttacctttcctctctatggaactatgggaaacgccgctccacaacaacgtatcgttgctcaactaggtcagggtgtctacagaaccttgtcttccaccttgtacagaagacccttcaatatcggtatcaacaaccagcaactttccgttcttgacggaacagagttcgcctatggaacctcttctaacttgccatccgctgtttacagaaagagcggaaccgttgattccttggacgaaatcccaccacagaacaacaatgtgccacccaggcaaggattctcccacaggttgagccacgtgtccatgttccgttccggattcagcaacagttccgtgagcatcatcagagctcctatgttctcttggatacatcgtagtgctgagttcaacaacatcatcgcatccgatagtattactcaaatccctgcagtgaagggaaactttctcttcaacggttctgtcatttcaggaccaggattcactggtggagacctcgttagactcaacagcagtggaaataacattcagaatagagggtatattgaagttccaattcacttcccatccacatctaccagatatagagttcgtgtgaggtatgcttctgtgacccctattcacctcaacgttaattggggtaattcatccatcttctccaatacagttccagctacagctacctccttggataatctccaatccagcgatttcggttactttgaaagtgccaatgcttttacatcttcactcggtaacatcgtgggtgttagaaactttagtgggactgcaggagtgattatcgacagattcgagttcattccagttactgcaacactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgcctcgacgagaagcgtgaactctccgagaaagttaaacacgccaagcgtctcagcgacgagaggaatctcttgcaagactccaacttcaaagacatcaacaggcagccagaacgtggttggggtggaagcaccgggatcaccatccaaggaggcgacgatgtgttcaaggagaactacgtcaccctctccggaactttcgacgagtgctaccctacctacttgtaccagaagatcgatgagtccaaactcaaagccttcaccaggtatcaacttagaggctacatcgaagacagccaagaccttgaaatctactcgatcaggtacaatgccaagcacgagaccgtgaatgtcccaggtactggttccctctggccactttctgcccaatctcccattgggaagtgtggagagcctaacagatgcgctccacaccttgagtggaatcctgacttggactgctcctgcagggatggcgagaagtgtgcccaccattctcatcacttctccttggacatcgatgtgggatgtactgacctgaatgaggacctcggagtctgggtcatcttcaagatcaagacccaagacggacacgcaagacttggcaaccttgagtttctcgaagagaaaccattggtcggtgaagctctcgctcgtgtgaagagagcagagaagaagtggagggacaaacgtgagaaactcgaatgggaaactaacatcgtttacaaggaggccaaagagtccgtggatgctttgttcgtgaactcccaatatgatcagttgcaagccgacaccaacatcgccatgatccacgccgcagacaaacgtgtgcacagcattcgtgaggcttacttgcctgagttgtccgtgatccctggtgtgaacgctgccatcttcgaggaacttgagggacgtatctttaccgcattctccttgtacgatgccagaaacgtcatcaagaacggtgacttcaacaatggcctcagctgctggaatgtgaaaggtcatgtggacgtggaggaacagaacaatcagcgttccgtcctggttgtgcctgagtgggaagctgaagtgtcccaagaggttagagtctgtccaggtagaggctacattctccgtgtgaccgcttacaaggagggatacggtgagggttgcgtgaccatccacgagatcgagaacaacaccgacgagcttaagttctccaactgcgtcgaggaagaaatctatcccaacaacaccgttacttgcaacgactacactgtgaatcaggaagagtacggaggtgcctacactagccgtaacagaggttacaacgaagctccttccgttcctgctgactatgcctccgtgtacgaggagaaatcctacacagatggcagacgtgagaacccttgcgagttcaacagaggttacagggactacacaccacttccagttggctatgttaccaaggagcttgagtactttcctgagaccgacaaagtgtggatcgagatcggtgaaaccgagggaaccttcatcgtggacagcgtggagcttctcttgatggaggaataatgagatcccgtcctttgtcttcaattttgagggctttttactgaataagtatgtagtactaaaatgtatgctgtaatagctcatagtgagcgaggaaagtatcgggctatttaactatgacttgagctccatctatgaataaataaatcagcatatgatgcttttgttttgtgtacttcaactgtctgcttagctaatttgatatggttggcacttggcacgtataaatatgctgaagtaatttactctgaagctaaattaactagattagatgagtgtattatatacaaaaggcattaaatcagatacatcttagacaaattgtcacggtctaccagaaaagaaattgcatttgtttttgggtctttcagactgacaagatcgatctgaagtctaaacaattctaagaggtatcatgtagcaatgtcctgccacaatattgaattgacctgcagcccgggcggccgcatcgatcgtgaagtttctcatctaagcccccatttggacgtgaatgtagacacgtcgaaataaagatttccgaattagaataatttgtttattgctttcgcctataaatacgacggatcgtaatttgtcgttttatcaaaatgtactttcattttataataacgctgcggacatctacatttttgaattgaaaaaaaattggtaattactctttctttttctccatattgaccatcatactcattgctgatccatgtagatttcccggacatgaagccat

SEQ ID NO: 9 - DNA, 14416 bp, Artificial sequence
  Contig of 5′ flanking sequence, inserted DNA and 3′ Flanking Sequence
gggaaaatccctcttccatattaagaacataaaaatcaacaggaaaaataagttcaccaacccgaaccagcacatcctctatgaaacctgcggggtaagcagcacttctattttccaaatgaatcaccacatctgtagattgcaaaggtccaagagataaagaattgaaaatggacagaggggtgacactaactgatgctcctagatctagcattgtattatcaaatttactgttcccaataatgcaaggtatacagaaagtacctgggtccttacatttctcaggaatgtaaggaacaaatttacctatcaatgctgacacatttctgcccatgctaatcctttcattgcctttgagcttccttttgtgggtgcacaactcctttagaaacttgacacatcttggaatctgcttgatggcatctagcagaggtatgttcacctctactttcctgaaggtctccaagatctccttttctgcttcttccattttttttgtttggaattgctcaaggttggaatggaagagggataagaggctgcggtaagtcagaattactagaagaaggtccacctgcatgaaaatttttgttaggaagctttctcttttgtgcaactatctcatcctctttttcaggtgtagaatgaagcttgacaggttcaggtgcgggtgctgctactggtggaggtacttgaatttggttgtcagacctcaaggtgatgacactcacatttttcggattttgcacagtttgtgaaggcaatttgtcagaattttgggaatgagcttggttcaactgagtagccatccgccccatctgatttgtcagactctgaatgaaggctcttgtctcttgctgaaattgcatattctggatggtcatttgcctcactaactcttctaaggaaggttaaggaggagtctcagttgcttgttgtctttgttgtgactgttgttgttgttgctgctgtattggaggaggaacatatggtttgcttggaccagcaacattctggaaaggagggacagactgttgttgttgtgaaggacttgcccatctcatatttggatgatttctccaacctggattgtatctgttgcttggaagatcataattattttgctattgttggttttgctgttgagggggtctattataaatgtttgcagcataagcttcaggttgttcattgactccagattactgcaaagaaggacaaagatctgtatggtgatctgcagaagaacatataccacagactcttgtaacaggtgcaaatttctgattcatggcaagctgagttactaggttgaccaaggcatcaagttttccctcaagctttttattttcagtagataaagatgaatctgtggccacctcatcgactcctctaaggacaatagcatcatttcttgcactgaattgttgggagttggaagccttcttctcaatcaaattcctagcctcagcaggggtcatatcacgaagagctccaccactggcagcatcaatcatactcctctccatgttgctaagtccctcatagaaatattgaagaaggagttgctcagaaatctggtggtgaggacagcttgcacacaatttcttgaatctttctcagtactcatacaagctctctccactaagttgcctgatgcctgaaatttcttttctgatggcagtggtcctagatgcagggaagaatttctccaagaacaccctcttaaggtcatcccagctgaaaatggacctgggagcaaggtagtagagccaatcttttgtcactacctccagagaatgaggaaaagcctttagaaagatatgatcttcttggacatcagggggcttcatggtggaacaaacaatatggaactccttaagatgcttatgaggatcttcacctagaagaccatgaaacttgggtagcaaatgtattagtccagtcttgagaacatatggaacaccctcatcaggatattgaatgcacaagttttcataagtgaaatcaggtgcagccatctccctaagagtcctctcacgaggtggaggtttagccatgttctcagtatgaaaattagtagttgaatgctcaaaatcagaatattcagaatcaccagaaacaaaatactcagaatgctcaaaatgctcaaaatgcacataatgattaggatgcacactatgcctaactaatctatgaaaggttctatctatttcaggatcgaagggttataaatcacctagattgcccctagtcatgcactatatgtagcaaataatgtgttctcaaacaagcaccaagggagggttaaaactacaactatagtcaaatgatatccaaatgagttgaaattttgtgagcagcaccctaaaatcatgaaaagatagcacaaaaaatttcaaacgaaaattcaaagtctaactatgaaaactacttaagaaaagtttagaaaaataggacaataatacttgaaaaataaaaaaaaacatagtaaacagctgatttttcgagtttgggagactccaaccggctaaaacgggttgccacaatatgagaaatttttttctaccccaaatgccacaatatgagaaagttttgctaaaatctagttcccaaaatttttgtctctctcaaattcaaccacaccaagtgctcctagtatttttcacacaaaaaatcagccaaaaataacaactctaactatcaaaacaaaaacagctaattaaattgcaaaatcagtcgctaattcctagtcactaatcactgttcacagcaaaacaccaactgaatcagtcgctaaacagtcgctaaacaggagacgcaactgaaatgcaaaacagaatgctacacaaaacaaaacaactaaacactattatgaacctttggcccactgctccccgacaacggcgccaaatttgatcgaggtcgtacccgaatcaaataaacattaaaaatgcagtatctaggaagtgatcctaggtcatctcccaacgagcaatggtcaaccaatgttcataatagatagtgataaaacaataacgaattggggggggggggtatttgtttttgtaatttaaacaacaagcaaattttaattagaaaataacagaattaaaacatgttatttccccttgattcataagcaagtctcttatcctaggttaggaggatttatccctaaccagttcaaccacttaatccaaccctaaattaaattactaagcgaaaattaacataaggttgtctttatatgattaagcaacacatacaccaattaatcatgaacaaaatcgatcattaagcatcaacataaattaagcgcaaagataattaatcaagcactaagcatgcatggattagtagcaacaaatacagagtaattggtggagatgaaaaactgatcaatattcaatagtaataacaaaacctcaaagagagttgtgcttgattctcaagagaaaacaacgctggagacttagccttccattaatcagtagaaaacgaaattgtagaaaacgaattttattctatgtgaacaatgtgcatgaacagtaataaaaactggaattgcaaaaccctaaaattattcttctctccaaaaaaactccctaaactaaaaccctggtgctattatataggtcctcagccccaaagcttacaaatctattttcagtccaaacccataaacgaaataaaataaaatctggacaagataagataagattggatgaaataaaatctggacgaaataaaatctggataagataagatttgataaaataaaattgtctgctcttttcaagtccaagcccaattccggattcaagcccaattttttataattcttctgaaattaaattaaaaatacgaaattagtcaagtaggcccaaatgataaaactgcataattaatttgacaattaaggctaatcagtaattaaaatagtgacaaaaagggttaagaaataggagaataatgacacatcacccatatggggagcaattctaaaatgcatttgagttctttaacctgagacacagtgcagtagagtctccaaggattcattgtgccttttattttatatgatggggtcactacattggccttgtcaaagaaactgaatttgggggattaaagaaacacaaaataaaaacaaatgaaactagttaatagaaatgttgcctattgcttcttggaaaaagtccaaccatttgtgatttggataaaattcatattacccacttgtagcttgttcaatcaaacactagatttggataaaatctcactcctagatatacctcaagggataatatgaccaacattagtcatttttagaaagtaaagtggacaaatttgagatttcattccttaatgacattataaacatgtattttttccatgaccctttttcaatgtaagtacaatttatcccttagtttagatactctatatatgcatgttacgtagttgatgaaaacatacctaagttgttgtgtatggttaagtttgcgactacctctgatatcaaactcctcatctccaatctcatacaaaagatacttgtcacttggtacctgaaccttgtcagtttgcagttgtgagtttcttctgaagccacacgcttgtatagtaaccagaagccaggagggagtcctctaaggctctaactcgtattttccgtggaagtacattttttttcttaaagaaaacagagatagtttaccaatgataatatttctttagccaaataggaccatcatagaaaacaaaactcttcttctaagtatttaatgcaactacatatttagggtgcgtttgattcgctaaaaaataagggtctagacaacacaaaaatatttttccaacgtttgattttaaaaatggctgagagacaatacaaaataaagaatgatgaactggacaaaaacctaaaaacttgtaactcactgaatctcatacaactttttgttcagtgtctaaaaaaagtaaaaatacaatattattcctattttttactttgattatctcacaccttctttctactcatttgtttcacttcacctctccagtgggcaccttggtttgtcggcgagagtcgtatggacttttgttgtttcctttttgctcattatttctttcttttcattgttaatttattcaaatgttcccatcatcatcttactccttcttgttatgttttttttctttggccaactccaacgaggccgtgccgcgaccaccatcatcacgaccttatggcggcctcacgccgcaaggccctgcacccagtggcatcaggggtcatgcctccttcttaaaggtgtctctcttttgttatgtcgtcaaagtgttgctaattcacctagaatttttcaatgaatccctttacttgtgggttagtctaggtcgctctgcccggttccaaccctagcccaaaaaaaaatgaaatgggtaggaaaggcgggcctagtttgaattaaaataaatcatgctaagatattgataactgctatgtataggtatattttgggattaaattatataggaattagtaatttttctctcttatttcttcctttttgttcaaataattggaattctaacatcatttaagtttttatgtagaaaatattaaaagttgatgaatttatgatacttagtgaataattagagtagaaaaataaagtaaagcccaaaaaagaaaattggtgatatgaagatacatgcttagcatgccccaggcacgcttagtgtgtgtgtcaaacactgatagtttaaactgaaggcgggaaacgacaatctgatccccatcaagcttgatatcgaattcctgcagcccgggggatccactagttctagagcggccgcgttaactgcaggtcgacggatccccgggtaccgagctcgaattcaaatttattatgtgttttttttccgtggtcgagattgtgtattattctttagttattacaagacttttagctaaaatttgaaagaatttactttaagaaaatcttaacatctgagataatttcagcaatagattatatttttcattactctagcagtatttttgcagatcaatcgcaacatatatggttgttagaaaaaatgcactatatatatatatattattttttcaattaaaagtgcatgatatataatatatatatatatatatatgtgtgtgtgtatatggtcaaagaaattcttatacaaatatacacgaacacatatatttgacaaaatcaaagtattacactaaacaatgagttggtgcatggccaaaacaaatatgtagattaaaaattccagcctccaaaaaaaaatccaagtgttgtaaagcattatatatatatagtagatcccaaatttttgtacaattccacactgatcgaatttttaaagttgaatatctgacgtaggatttttttaatgtcttacctgaccatttactaataacattcatacgttttcatttgaaatatcctctataattatattgaatttggcacataataagaaacctaattggtgatttattttactagtaaatttctggtgatgggctttctactagaaagctctcggaaaatcttggaccaaatccatattccatgacttcgattgttaaccctattagttttcacaaacatactatcaatatcattgcaacggaaaaggtacaagtaaaacattcaatccgatagggaagtgatgtaggaggttgggaagacaggcccagaaagagatttatctgacttgttttgtgtatagttttcaatgttcataaaggaagatggagacttgagaagttttttttggactttgtttagctttgttgggcgtttttttttttgatcaataactttgttgggcttatgatttgtaatattttcgtggactctttagtttatttagacgtgctaactttgttgggcttatgacttgttgtaacatattgtaacagatgacttgatgtgcgactaatctttacacattaaacatagttctgttttttgaaagttcttattttcatttttatttgaatgttatatatttttctatatttataattctagtaaaaggcaaattttgcttttaaatgaaaaaaatatatattccacagtttcacctaatcttatgcatttagcagtacaaattcaaaaatttcccatttttattcatgaatcataccattatatattaactaaatccaaggtaaaaaaaaggtatgaaagctctatagtaagtaaaatataaattccccataaggaaagggccaagtccaccaggcaagtaaaatgagcaagcaccactccaccatcacacaatttcactcatagataacgataagattcatggaattatcttccacgtggcattattccagcggttcaagccgataagggtctcaacacctctccttaggcctttgtggccgttaccaagtaaaattaacctcacacatatccacactcaaaatccaacggtgtagatcctagtccacttgaatctcatgtatcctagaccctccgatcactccaaagcttgttctcattgttgttatcattatatatagatgaccaaagcactagaccaaacctcagtcacacaaagagtaaagaagaacaatggcttcctctatgctctcttccgctactatggttgcctctccggctcaggccactatggtcgctcctttcaacggacttaagtcctccgctgccttcccagccacccgcaaggctaacaacgacattacttccatcacaagcaacggcggaagagttaactgcatgcaggtgtggcctccgattggaaagaagaagtttgagactctctcttaccttcctgaccttaccgattccggtggtcgcgtcaactgcatgcaggccatggacaacaacccaaacatcaacgaatgcattccatacaactgcttgagtaacccagaagttgaagtacttggtggagaacgcattgaaaccggttacactcccatcgacatctccttgtccttgacacagtttctgctcagcgagttcgtgccaggtgctgggttcgttctcggactagttgacatcatctggggtatctttggtccatctcaatgggatgcattcctggtgcaaattgagcagttgatcaaccagaggatcgaagagttcgccaggaaccaggccatctctaggttggaaggattgagcaatctctaccaaatctatgcagagagcttcagagagtgggaagccgatcctactaacccagctctccgcgaggaaatgcgtattcaattcaacgacatgaacagcgccttgaccacagctatcccattgttcgcagtccagaactaccaagttcctctcttgtccgtgtacgttcaagcagctaatcttcacctcagcgtgcttcgagacgttagcgtgtttgggcaaaggtggggattcgatgctgcaaccatcaatagccgttacaacgaccttactaggctgattggaaactacaccgaccacgctgttcgttggtacaacactggcttggagcgtgtctggggtcctgattctagagattggattagatacaaccagttcaggagagaattgaccctcacagttttggacattgtgtctctcttcccgaactatgactccagaacctaccctatccgtacagtgtcccaacttaccagagaaatctatactaacccagttcttgagaacttcgacggtagcttccgtggttctgcccaaggtatcgaaggctccatcaggagcccacacttgatggacatcttgaacagcataactatctacaccgatgctcacagaggagagtattactggtctggacaccagatcatggcctctccagttggattcagcgggcccgagtttacctttcctctctatggaactatgggaaacgccgctccacaacaacgtatcgttgctcaactaggtcagggtgtctacagaaccttgtcttccaccttgtacagaagacccttcaatatcggtatcaacaaccagcaactttccgttcttgacggaacagagttcgcctatggaacctcttctaacttgccatccgctgtttacagaaagagcggaaccgttgattccttggacgaaatcccaccacagaacaacaatgtgccacccaggcaaggattctcccacaggttgagccacgtgtccatgttccgttccggattcagcaacagttccgtgagcatcatcagagctcctatgttctcttggatacatcgtagtgctgagttcaacaacatcatcgcatccgatagtattactcaaatccctgcagtgaagggaaactttctcttcaacggttctgtcatttcaggaccaggattcactggtggagacctcgttagactcaacagcagtggaaataacattcagaatagagggtatattgaagttccaattcacttcccatccacatctaccagatatagagttcgtgtgaggtatgcttctgtgacccctattcacctcaacgttaattggggtaattcatccatcttctccaatacagttccagctacagctacctccttggataatctccaatccagcgatttcggttactttgaaagtgccaatgcttttacatcttcactcggtaacatcgtgggtgttagaaactttagtgggactgcaggagtgattatcgacagattcgagttcattccagttactgcaacactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgcctcgacgagaagcgtgaactctccgagaaagttaaacacgccaagcgtctcagcgacgagaggaatctcttgcaagactccaacttcaaagacatcaacaggcagccagaacgtggttggggtggaagcaccgggatcaccatccaaggaggcgacgatgtgttcaaggagaactacgtcaccctctccggaactttcgacgagtgctaccctacctacttgtaccagaagatcgatgagtccaaactcaaagccttcaccaggtatcaacttagaggctacatcgaagacagccaagaccttgaaatctactcgatcaggtacaatgccaagcacgagaccgtgaatgtcccaggtactggttccctctggccactttctgcccaatctcccattgggaagtgtggagagcctaacagatgcgctccacaccttgagtggaatcctgacttggactgctcctgcagggatggcgagaagtgtgcccaccattctcatcacttctccttggacatcgatgtgggatgtactgacctgaatgaggacctcggagtctgggtcatcttcaagatcaagacccaagacggacacgcaagacttggcaaccttgagtttctcgaagagaaaccattggtcggtgaagctctcgctcgtgtgaagagagcagagaagaagtggagggacaaacgtgagaaactcgaatgggaaactaacatcgtttacaaggaggccaaagagtccgtggatgctttgttcgtgaactcccaatatgatcagttgcaagccgacaccaacatcgccatgatccacgccgcagacaaacgtgtgcacagcattcgtgaggcttacttgcctgagttgtccgtgatccctggtgtgaacgctgccatcttcgaggaacttgagggacgtatctttaccgcattctccttgtacgatgccagaaacgtcatcaagaacggtgacttcaacaatggcctcagctgctggaatgtgaaaggtcatgtggacgtggaggaacagaacaatcagcgttccgtcctggttgtgcctgagtgggaagctgaagtgtcccaagaggttagagtctgtccaggtagaggctacattctccgtgtgaccgcttacaaggagggatacggtgagggttgcgtgaccatccacgagatcgagaacaacaccgacgagcttaagttctccaactgcgtcgaggaagaaatctatcccaacaacaccgttacttgcaacgactacactgtgaatcaggaagagtacggaggtgcctacactagccgtaacagaggttacaacgaagctccttccgttcctgctgactatgcctccgtgtacgaggagaaatcctacacagatggcagacgtgagaacccttgcgagttcaacagaggttacagggactacacaccacttccagttggctatgttaccaaggagcttgagtactttcctgagaccgacaaagtgtggatcgagatcggtgaaaccgagggaaccttcatcgtggacagcgtggagcttctcttgatggaggaataatgagatcccgtcctttgtcttcaattttgagggctttttactgaataagtatgtagtactaaaatgtatgctgtaatagctcatagtgagcgaggaaagtatcgggctatttaactatgacttgagctccatctatgaataaataaatcagcatatgatgcttttgttttgtgtacttcaactgtctgcttagctaatttgatatggttggcacttggcacgtataaatatgctgaagtaatttactctgaagctaaattaactagattagatgagtgtattatatacaaaaggcattaaatcagatacatcttagacaaattgtcacggtctaccagaaaagaaattgcatttgtttttgggtctttcagactgacaagatcgatctgaagtctaaacaattctaagaggtatcatgtagcaatgtcctgccacaatattgaattgacctgcagcccgggcggccgcatcgatcgtgaagtttctcatctaagcccccatttggacgtgaatgtagacacgtcgaaataaagatttccgaattagaataatttgtttattgctttcgcctataaatacgacggatcgtaatttgtcgttttatcaaaatgtactttcattttataataacgctgcggacatctacatttttgaattgaaaaaaaattggtaattactctttctttttctccatattgaccatcatactcattgctgatccatgtagatttcccggacatgaagccatcaaaaagtaggactaatttaggaaagcaagctaattcaagaaagtgaaggcacgcttagtgtgagacacgtgttgagcgcgattactgccactcactaaccacacaagtgcactcagtgcgaaggttgcttaaaaattaagttgattcgcacttataaaagaaggatagagatgaaggaaaaaacacagaaaatacaattccttatagaagacaaaggctagaagaagcaaacgcaaacattagaagtcattccttccctcaattccctttttcaatttccccttttactaaatattctcctcttgcaattataaagcctcctatgacaatgacaagctaaactctcctttgttgggaacttatcagtcaactgctcttaatataatttctcttcctatctattatgaatattcactacaagaaatatgcccatttgccagggatttttgacagggacattaacccctggcaaatttcccagggactaagccaaggaaacccctggcaaaatgacatttgagaaggctgggaccacttacatttacacaggggtttgtccctcgcaaaaatacaaaagccttggcaaaaaaaagagcgggaaatgaattttaaaacagcatgttgttttcacacagccaaacacacgggtatgccctcgttttctgtaaagctgacggaatcttcccataagtcaacacgacatgaccatgcactgcaaaaagctgtgcggcccagacgtgacaggggtgttacccctcggaaatggcttgcagcccctggcaaaaaggaatccctgctttcctagctacaccgttctgctcatatagctgaagctaggaggttagcctttgactctgttgttttgcgaggggcattccgtgagttattccctgggtttttttacactatatagccaaaccgcgtgtttatcctcatgctcagtgttgtgtttttgaaacttagaaaaattttcggtttccatttccatcctcaccagttcattttcagtccattatcattcagttcatacacttgttctataatttggtaacactcttttcacttattatatttttctgtttttatttgttactacttattaacataaatattttttattgtatcagtgtccaaatttgcctcctcctgctgctccttgctctctgaatttgttctcttaagcttcaacaagttagtaatttttctacttataattttagatatatgatgtttatatatatgatgttataattttgcatgatctgtcaaagaaaatatgatgtttctacttgcatgatgtgttataatatatgatgtttatatatatttcgaattttgttgttaataaaactgtttaattagaaactgtataatttttttgtttaataaaactgtttaattttgcatgatctgtttaataaaactgtttatataaaactgtttatatataatatatgatgttaacatttttaaaactgtttataaaacagtttagttagaaaaaatgttaaaactagagaaaaaaatgtataataaaactgtgtcagtacagcagcgcgtcagaaaagtgtgcagatgcgtcagtgagaagacaggggctaagacagggattttgacagggaattttgccagggattttgccagggtcagcccctcgtttttttgccaggggtgaaatccctggcaaactgatttgcgatgggcgtttttcccagggattcagcccctggcaaaatccctggcaaacgtccatttcccagggctttttgttcttttcccagggaatccgcccctggcaaacgagcttgtttcttgtagtgattacttttgcattagtttttcctgtatttaattttattgtttatggcttgattacccatttgcattataagttttaggggtagcgttgaaaagtgttattctctaatagaactggaaaagagtatttaaataacttcatcactagggatacattgattttatttagcttattatatatctctattattaatgtaatttaactattttatctctgcaaagtgatttgggagagaagatagataagttagactctttcactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgaaggg

(19) United States
(12) Patent Application Publication
(10) Pub. No.: US 2016/0029631 A1
(43) Pub. Date: Feb. 4, 2016

(54) METHOD FOR COMBATING PESTS

(71) Applicant: BAYER CROPSCIENCE AKTIENGESELLSCHAFT, Monheim am Rhein (DE)

(72) Inventors: Elke HELLWEGE, Langenfeld (DE); Koen VAN DEN EYNDE, Beijing (CN)

(73) Assignee: Bayer Cropscience Aktiengesellschaft, Monheim am Rhein (DE)

(21) Appl. No.: 14/784,044

(22) PCT Filed: Apr. 15, 2014
(86) PCT No.: PCT/EP2014/057623

§ 371 Date: Oct. 13, 2015

(30) Foreign Application Priority Data
Apr. 19, 2013 (EP) 13164468.4

(51) Int. Cl. A01N 43/713; A01N 63/02; A01N 41/10; A01N 43/56

(52) U.S. Cl. CPC A01N 43/713; A01N 43/56; A01N 63/02; A01N 41/10

(57) ABSTRACT

Method for improving the utilization of the production potential of transgenic soybean plants in the absent of a pest and a method for controlling/combating/treating pests by treating Bt-soybean plants with at least one compound of I-1 to I-4.

Bt stands for Bacillus thuringiensis (Bt) a common soil bacterium so called because it was first isolated in the Thuringia region of Germany.

Bt produces a protein that paralyzes the larvae of some harmful insects, including the cotton bollworm and the Asian and European corn borers, all of which are common plant pests whose infestations produce devastating effects on important crops.

Bt is easily cultured by fermentation. Thus, over the last 40 years, Bt has been used as an insecticide by farmers worldwide. Organic farming in particular has benefited from Bt insecticide, as it is one of the very few pesticides permitted by organic standards. The insecticide is applied either as a spray, or as ground applications. It comes in both granules and liquefied form.

Scientists have taken the Bt gene responsible for the production of the insecticidal protein from the bacterium and incorporated it into the genome of plants. Thus, these plants have a built-in mechanism of protection against targeted pests. The protein produced by the plants does not get washed away, nor is it destroyed by sunlight. The plant is thus protected from, e.g., the bollworm or the corn borer round the clock regardless of the situation.

In 1999, it was reported that pollen from Bt corn had a negative impact on Monarch butterfly larvae. This report raised concerns and questions about the risks of Bt crops on non-target organisms. Recent studies, however, show that Bt corn poses “negligible” threat to Monarch butterflies in the field. A collaborative research effort by scientists in the US and in Canada has produced information to develop a formal risk assessment of the impact of Bt corn on Monarch butterfly populations. They concluded that in most commercial hybrids, Bt expression in pollen is low, and laboratory and field studies show no acute toxic effects at any pollen density that would be encountered in the field.

At the end of 2011, an estimated 23.9 million hectares of land were planted with crops containing the Bt gene.

Ryanodine receptor modulators, for example diamides (e.g. Chlorantraniliprole (I−1), Cyantraniliprole (I-2), and Flubendiamide (I-3) (known from EP-A 1 006 107) and diamide compound (I-4) (known from WO 2007/144100) are known for their insecticidal activity. Ryanodine receptor modulators are for example:

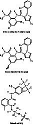 [SMILES: CNC(=O)c1cc(Cl)cc(C)c1NC(=O)c1cc(Br)nn1-c1ncccc1Cl ; CNC(=O)c1cc(C#N)cc(C)c1NC(=O)c1cc(Br)nn1-c1ncccc1Cl ; Cc1cc(C(F)(C(F)(F)F)C(F)(F)F)ccc1NC(=O)c1cccc(I)c1C(=O)NC(C)(C)CS(C)(=O)=O]

and diamide compound (I-4) which can be (I-4-a) or a regioisomeric mixture of (I-4-a) and (I-4-b)

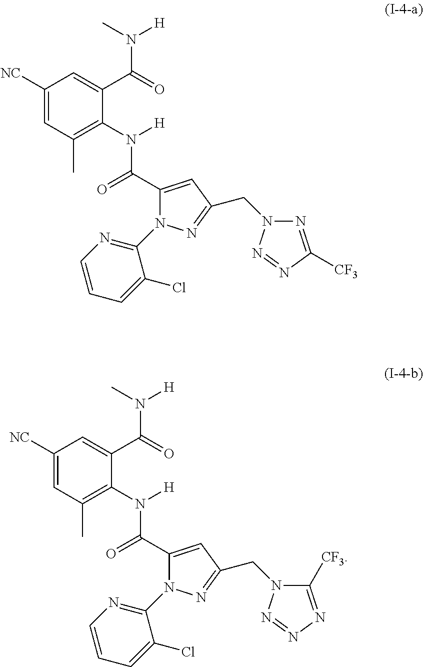 [SMILES: CNC(=O)c1cc(C#N)cc(C)c1NC(=O)c1cc(Cn2nnc(C(F)(F)F)n2)nn1-c1ncccc1Cl ; CNC(=O)c1cc(C#N)cc(C)c1NC(=O)c1cc(Cn2nnnc2C(F)(F)F)nn1-c1ncccc1Cl]

It was now surprisingly found that the treatment of Bt-soybean plants, especially Bt-soybean plants having a Cry1Ac and/or a Cry1F with ryanodine receptor modulators are a good method to control/combat/treat insecticidal and/or nematicidal pests, e.g., the treatment of Bt-soybean, especially the treatment of Intacta RR2 PRO™ soybean from Monsanto (comprising event MON87701) with diamides, especially flubendiamide, offers a good method to control/combat/treat insect and/or nematode pests.

Thus, a first aspect of the present invention refers to a method for controlling pests, characterized in that a Bt-soybean plant is treated with an effective amount of at least one ryanodine receptor modulator compound selected from the group consisting of

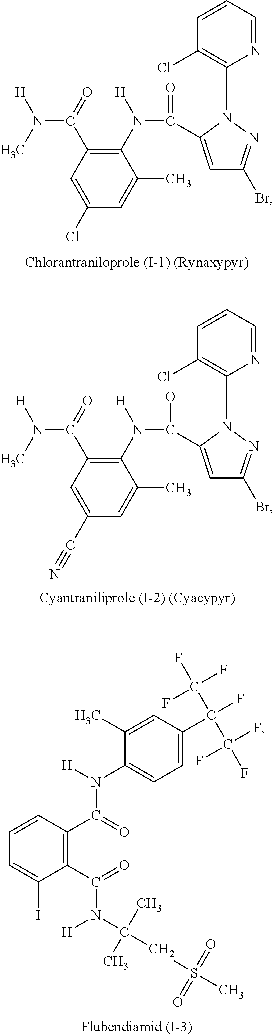 [SMILES: CNC(=O)c1cc(Cl)cc(C)c1NC(=O)c1cc(Br)nn1-c1ncccc1Cl ; CNC(=O)c1cc(C#N)cc(C)c1NC(O)c1cc(Br)nn1-c1ncccc1Cl ; Cc1cc(C(F)(C(F)(F)F)C(F)(F)F)ccc1NC(=O)c1cccc(I)c1C(=O)NC(C)(C)CS(C)(=O)=O]

or diamide compound (I-4) which can be (I-4-a) or a regioisomeric mixture of (I-4-a) and (I-4-b)

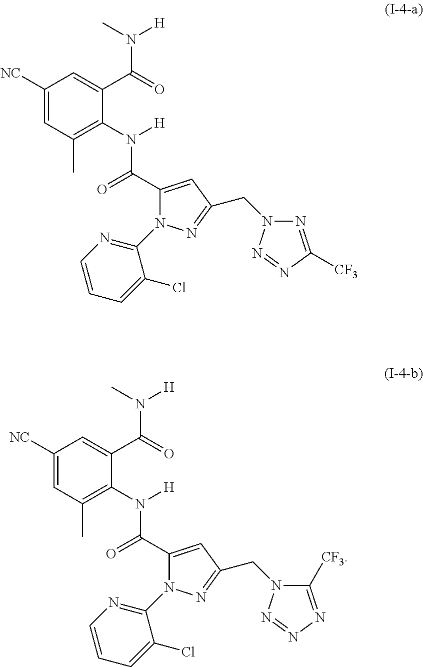 [SMILES: CNC(=O)c1cc(C#N)cc(C)c1NC(=O)c1cc(Cn2nnc(C(F)(F)F)n2)nn1-c1ncccc1Cl ; CNC(=O)c1cc(C#N)cc(C)c1NC(=O)c1cc(Cn2nnnc2C(F)(F)F)nn1-c1ncccc1Cl]

Preferably, the mixing ratio of (II-2-a) to (II-2-b) is at least 70:30. More preferably, the mixing ratio of (II-2-a) to (II-2-b) is at least 80:20; 81:19; 82:18; 83:17; 84:16; 85:15, 86:14; 87:13; 88:12; 89:11; 90:10, 91:9; 92:8; 93:7; 96:6; 95:5 or higher.

In one embodiment, the ryanodine receptor modulator compound is compound (I-3).

In one embodiment, the ryanodine receptor modulator compound is compound (I-4).

In one embodiment, the ryanodine receptor modulator compound is compound (I-1) or (I-2).

In one preferred embodiment, said method is characterized in that the Bt-soybean plant comprises at least one cry-gene or a cry-gene fragment coding for a Bt toxin.

In one preferred embodiment, said method is characterized in that the Bt-soybean plant comprises at least one cry1A-gene or cry1A-gene fragment coding for a cry1A Bt toxin, preferably a cry1A-gene or cry1A-gene fragment selected from the sub-families cry1Aa, cry1Ab, cry1Ac or hybrids thereof (e.g. a hybrid of cry1Ac and cry1Ab).

In one preferred embodiment, said method is characterized in that said Bt-soybean plant further comprising a cryF gene or cryF-gene fragment coding for a Bt toxin.

In one preferred embodiment, said method is characterized in that the Bt-soybean plant comprises event MON87701 and optionally also event MON89788 (Glyphosate herbicide tolerance).

In another preferred embodiment, said method is characterized in that said soybean plant comprising DNA that comprises a first sequence selected from the group consisting of bp 1385-1415 of SEQ ID NO: 1; bp 1350-1450 of SEQ ID NO: 1; bp 1300-1500 of SEQ ID NO: 1; bp 1200-1600 of SEQ ID NO: 1; bp 137-168 of SEQ ID NO:2; bp 103-203 of SEQ ID NO:2; and bp 3-303 of SEQ ID NO:2; and a second sequence selected from the group consisting bp 2680-2780 of SEQ ID NO: 3; bp 2630-2830 of SEQ ID NO: 15; bp 2530-2930 of SEQ ID NO: 15; bp 9071-9171 of SEQ ID NO: 15; bp 9021-9221 of SEQ ID NO: 15; and, bp 8921-9321 of SEQ ID NO: 15 said first and second sequences being diagnostic for the presence of soybean event pDAB9582.814.19.1:pDAB4468.04.16.1. pDAB9582.814.19.1:pDAB4468.04.16.1 are disclosed in WO 2013/016516.

In one preferred embodiment, said method is characterized in that said soybean plant comprising a nucleotide sequence of SEQ ID NO: 4, SEQ ID NO:5, or complement thereof.

In one preferred embodiment, said method is characterized in that said soybean plant comprising a nucleotide sequence of SEQ ID NO:6, SEQ ID NO:7, SEQ ID NO:9 or complement thereof.

In one preferred embodiment, said method is characterized in that said soybean plant comprising a nucleotide sequence of SEQ ID NO:6 from positions 1 to 5757, the nucleotide sequence of SEQ ID NO:8 from positions 1 to 6426, and the nucleotide sequence of SEQ ID NO:7 from positions 379 to 2611, or complement thereof.

In one preferred embodiment, said method is characterized in that said soybean plant comprising a nucleotide sequence essentially of the nucleotide sequence of SEQ ID NO: 9 or complement thereof.

In another preferred embodiment, said method is characterized in that said pest is selected from the group consisting of Pseudoplusia includens (soybean looper), Anticarsia gemmatalis (velvet bean caterpillar) and Spodoptera frugiperda (fall armyworm), and Helicoverpa spp (corn earworm).

In another preferred embodiment, said method is characterized in that the use form of the ryanodine receptor modulator is present in a mixture with at least one mixing partner.

A second aspect refers to a method for improving the utilization of the production potential of transgenic soybean plants in the absent of a pest. Preferred embodiments of this aspect are identical to the preferred embodiments disclosed for the first aspect of the present invention.

A third aspect refers to a synergistic composition comprising Bt toxins encoded by a nucleotide sequence that comprises
a first sequence selected from the group consisting of bp 1385-1415 of SEQ ID NO: 1; bp 1350-1450 of SEQ ID NO: 1; bp 1300-1500 of SEQ ID NO: 1; bp 1200-1600 of SEQ ID NO: 1; bp 137-168 of SEQ ID NO:2; bp 103-203 of SEQ ID NO:2; and bp 3-303 of SEQ ID NO:2; and a second sequence selected from the group consisting bp 2680-2780 of SEQ ID NO: 3; bp 2630-2830 of SEQ ID NO: 15; bp 2530-2930 of SEQ ID NO: 15; bp 9071-9171 of SEQ ID NO: 15; bp 9021-9221 of SEQ ID NO: 15; and, bp 8921-9321 of SEQ ID NO: 15 or
a nucleotide sequence of SEQ ID NO: 4, SEQ ID NO:5, or complement thereof.
   and a ryanodine receptor modulator as described herein.

A fourth aspect refers to a Bt-soybean plant, characterized in that at least 0.00001 g of a ryanodine receptor modulator as described herein is attached to it.

SEQ ID No: 1 (disclosed in WO 2013/016516) is the 5′ DNA flanking border sequence for soybean event pDAB9582.814.19.1. Nucleotides 1-1400 are genomic sequence. Nucleotides 1401-1535 are a rearranged sequence from pDAB9582. Nucleotides 1536-1836 are insert sequence.

SEQ ID No: 2 (disclosed in WO 2013/016516) is the 3′ DNA flanking border sequence for soybean event pDAB9582.814.19.1. Nucleotides 1-152 are insert sequence. Nucleotides 153-1550 are genomic sequence.

SEQ ID No: 3 (disclosed in WO 2013/016516) is the confirmed sequence of soybean event pDAB4468.04.16.1. Including the 5′ genomic flanking sequence, pDAB4468 T-strand insert, and 3′ genomic flanking sequence.

SEQ ID No:4 (disclosed in WO 2009/064652) is a A 20 nucleotide sequence representing the junction between the soybean genomic DNA and an integrated expression cassette. This sequence corresponds to positions 5748 to 5767 of SEQ ID NO:9. In addition, SEQ ID NO: 1 is a nucleotide sequence corresponding to positions 5748 through 5757 of SEQ ID NO:6 and the integrated right border of the TIC 107 expression cassette corresponding to positions 1 through 10 of SEQ ID NO:8. SEQ ID NO:1 also corresponds to positions 5748 to 5767 of the 5′ flanking sequence, SEQ ID NO:6.

SEQ ID No: 5 (disclosed in WO 2009/064652) is a 20 nucleotide sequence representing the junction between an integrated expression cassette and the soybean genomic DNA. This sequence corresponds to positions 12174 to 12193 of SEQ ID NO:9. In addition, SEQ ID NO:2 is a nucleotide sequence corresponding positions 6417 through 6426 of SEQ ID NO:8 and the 3′ flanking sequence corresponding to positions 379 through 388 of SEQ ED NO:7.

SEQ ID No: 6 (disclosed in WO 2009/064652) is the 5′ sequence flanking the inserted DNA of MON87701 up to and including a region of transformation DNA (T-DNA) insertion.

SEQ ID No: 7 (disclosed in WO 2009/064652) is the 3′ sequence flanking the inserted DNA of MON87701 up to and including a region of T-DNA insertion.

SEQ ID No: 8 (disclosed in WO 2009/064652) is the sequence of the integrated TIC 107 expression cassette, including right and left border sequence after integration.

SEQ ID No: 9 (disclosed in WO 2009/064652) is a 14,416 by nucleotide sequence representing the contig of the 5′ sequence flanking the inserted DNA of MON87701 (SEQ ID NO:6), the sequence of the integrated expression cassette (SEQ ID NO:8) and the 3′ sequence flanking the inserted DNA of MON87701 (SEQ ID NO: 7).

A nucleic acid molecule is said to be the “complement” of another nucleic acid molecule if they exhibit complete complementarity. As used herein, molecules are said to exhibit “complete complementarity” when every nucleotide of one of the molecules is complementary to a nucleotide of the other. Two molecules are said to be “minimally complementary” if they can hybridize to one another with sufficient stability to permit them to remain annealed to one another under at least conventional “low-stringency” conditions. Similarly, the molecules are said to be “complementary” if they can hybridize to one another with sufficient stability to permit them to remain annealed to one another under conventional “high-stringency” conditions. Conventional stringency conditions are described by Sambrook et al, 1989, and by Haymes et al, In: Nucleic Acid Hybridization, A Practical Approach, IRL Press, Washington, D.C. (1985), Departures from complete complementarity are therefore permissible, as long as such departures do not completely preclude the capacity of the molecules to form a double-stranded structure. In order for a nucleic acid molecule to serve as a primer or probe it need only be sufficiently complementary in sequence to be able to form a stable double-stranded structure under the particular solvent and salt concentrations employed.

As used herein, a “substantially homologous sequence” is a nucleic acid sequence that will specifically hybridize to the complement of the nucleic acid sequence to which it is being compared under high stringency conditions. Appropriate stringency conditions which promote DNA hybridization, for example, 6.0× sodium chloride/sodium citrate (SSC) at about 45<0>C, followed by a wash of 2.0×SSC at 50<0>C, are known to those skilled in the art or can be found in Current Protocols in Molecular Biology, John Wiley & Sons, N.Y. (1989), 6.3.1-6.3.6. For example, the salt concentration in the wash step can be selected from a low stringency of about 2.0×SSC at 50<0>C to a high stringency of about 0.2×SSC at 50<0>C. In addition, the temperature in the wash step can be increased from low stringency conditions at room temperature, about 22<0>C, to high stringency conditions at about 65<0>C. Both temperature and salt may be varied, or either the temperature or the salt concentration may be held constant while the other variable is changed. In a preferred embodiment, a nucleic acid of the present invention will specifically hybridize to one or more of the nucleic acid molecules set forth in SEQ ID NO: 1 and 2 or complements thereof or fragments of either under moderately stringent conditions, for example at about 2.0×SSC and about 65<0>C. In a particularly preferred embodiment, a nucleic acid of the present invention will specifically hybridize to one or more of the nucleic acid molecules set forth in SEQ ID NO: 1 and SEQ ID NO:2 or complements or fragments of either under high stringency conditions. In one aspect of the present invention, a preferred marker nucleic acid molecule of the present invention has the nucleic acid sequence set forth in SEQ ID NO:1 and SEQ ID NO:2 or complements thereof or fragments of either. In another aspect of the present invention, a preferred marker nucleic acid molecule of the present invention shares 80%, 81%, 82%, 83%, 84%, 85%, 86%, 87%, 88%, 89%, 90%, 91%, 92%, 93%, 94%, 95%, 96%, 97%, 98%, 99% and 100% sequence identity with the nucleic acid sequence set forth in SEQ ID NO:1 and SEQ ID NO:2 or complement thereof or fragments of either. In a further aspect of the present invention, a preferred marker nucleic acid molecule of the present invention shares 95% 96%, 97%, 98%, 99% and 100% sequence identity with the sequence set forth in SEQ ID NO:1 and SEQ ID NO: 2 or complement thereof or fragments of either. SEQ ID NO:1 and SEQ ID NO:2 may be used as markers in plant breeding methods to identify the progeny of genetic crosses similar to the methods described for simple sequence repeat DNA marker analysis, in “DNA markers: Protocols, applications, and overviews: (1997) 173-185, Cregan, et al., eds., Wiley-Liss NY”; all of which is herein incorporated by reference. The hybridization of the probe to the target DNA molecule can be detected by any number of methods known to those skilled in the art, these can include, but are not limited to, fluorescent tags, radioactive tags, antibody based tags, and chemiluminescent tags.

Regarding the amplification of a target nucleic acid sequence (e.g., by PCR) using a particular amplification primer pair, “stringent conditions” are conditions that permit the primer pair to hybridize only to the target nucleic-acid sequence to which a primer having the corresponding wild-type sequence (or its complement) would bind and preferably to produce a unique amplification product, the amplicon, in a DNA thermal amplification reaction. [0065] The term “specific for (a target sequence)” indicates that a probe or primer hybridizes under stringent hybridization conditions only to the target sequence in a sample comprising the target sequence.

“Controlling nematodes” according to the invention shall mean to kill nematodes or to prevent their development or growth by treating Bt-soybeans with a ryanodine receptor modulator. The efficacy is assessed by comparing the mortality of nematodes, the development of galls, the formation of cysts, the concentration of nematodes per volume of soil, of cysts, the concentration of nematodes per root, the number of nematode eggs per volume of soil, the motility of the nematodes between a plant, a plant part or the soil treated with a composition or combination according to the invention and the untreated plant, plant part or soil (100%). Preferred is a reduction by 25-50% in comparison with the untreated plant, plant part or soil, very preferred a reduction by 40-79%, and particularly preferred the complete killing and the complete prevention of the development or growth by a reduction from 70% to 100% in comparison with the untreated plant, plant part or soil.

“Controlling nematodes” according to the invention shall mean the control of the reproduction of the nematodes (e.g. development of cysts or eggs). The compositions according to the invention can used for keeping the plants healthy and can be used curatively, preventively or systemically for controlling nematodes.

The skilled person knows methods for determining the mortality of nematodes, the development of galls, the formation of cysts, the concentration of nematodes per volume of soil, of cysts, the concentration of nematodes per root, the number of nematode eggs per volume of soil, the motility of the nematodes between a plant, a plant part or the soil. The treatment according to the invention reduces the damages caused by nematodes to the plant and leads to an increase in yield.

### DETAILED DESCRIPTION

The invention relates to a method for controlling/combating/treating pests such as insects and/or nematodes characterized in that a Bt-soybean plant, parts thereof or the soil in which a Bt-soybean plant is growing is treated with at least one ryanodine receptor modulator compound. Preferred examples of ryanodine receptor modulators are

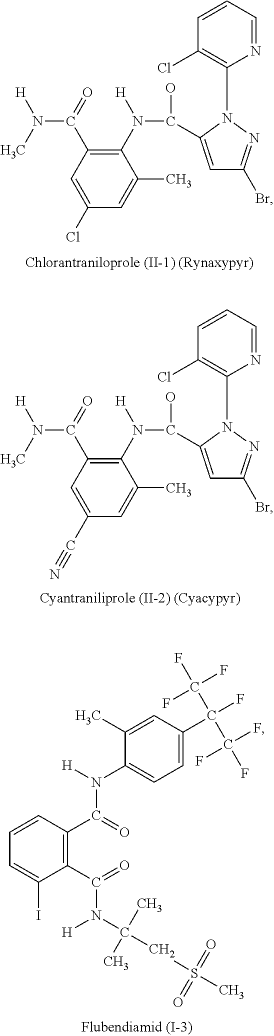 [SMILES: CNC(=O)c1cc(Cl)cc(C)c1NC(O)c1cc(Br)nn1-c1ncccc1Cl ; CNC(=O)c1cc(C#N)cc(C)c1NC(O)c1cc(Br)nn1-c1ncccc1Cl ; Cc1cc(C(F)(C(F)(F)F)C(F)(F)F)ccc1NC(=O)c1cccc(I)c1C(=O)NC(C)(C)CS(C)(=O)=O]

or diamide compound (I-4) which can be (I-4-a) or a regioisomeric mixture of (I-4-a) and (I-4-b)

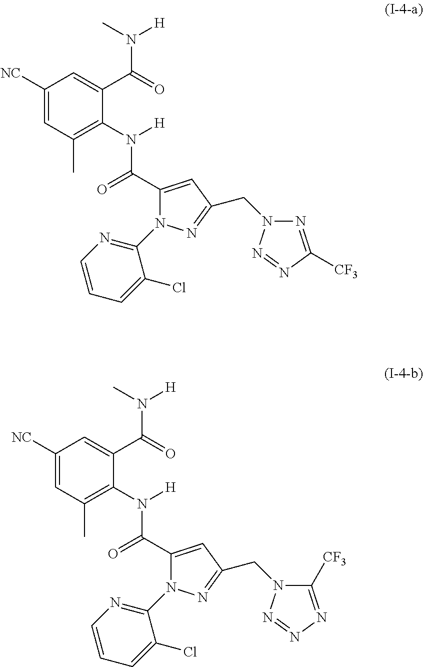 [SMILES: CNC(=O)c1cc(C#N)cc(C)c1NC(=O)c1cc(Cn2nnc(C(F)(F)F)n2)nn1-c1ncccc1Cl ; CNC(=O)c1cc(C#N)cc(C)c1NC(=O)c1cc(Cn2nnnc2C(F)(F)F)nn1-c1ncccc1Cl]

Moreover, the invention also relates to a method for improving the utilization of the production potential of transgenic Bt-soybean plants, i.e., the utilization of the production potential of transgenic Bt-soybean plants is improved by the treatment with a ryanodine receptor modulator even in the absence of combating insecticidal and/or nematicidal pests.

At certain application rates, the active compound combinations according to the invention may also have a strengthening effect in plants. Accordingly, they are also suitable for mobilizing the defense system of the plant against attack by unwanted microorganisms. This may, if appropriate, be one of the reasons of the enhanced activity of the combinations according to the invention, for example against fungi. Plant-strengthening (resistance-inducing) substances are to be understood as meaning, in the present context, those substances or combinations of substances which are capable of stimulating the defense system of plants in such a way that, when subsequently inoculated with unwanted microorganisms, the treated plants display a substantial degree of resistance to these microorganisms. In the present case, unwanted microorganisms are to be understood as meaning phytopathogenic fungi, bacteria and viruses. Thus, the substances according to the invention can be employed for protecting plants against attack by the abovementioned pathogens within a certain period of time after the treatment. The period of time within which protection is effected generally extends from 1 to 10 days, preferably 1 to 7 days, after the treatment of the plants with the active compounds.

“Nematodes” as used herein encompass all species of the phylum Nematoda and in particular species that are parasitic or cause health problems to plant or to fungi (for example species of the orders Aphelenchida, Meloidogyne, Tylenchida and others) or to humans and animals (for example species of the orders Trichinellida, Tylenchida, Rhabditina, and Spirurida) as well as other parasitic helminths.

“Nematodes” as used herein, refer to plant nematodes meaning all nematodes that cause damage to plants. Plant nematodes encompass plant parasitic nematodes and nematodes living in the soil. Plant parasitic nematodes include, but are not limited to, ectoparasites such as Xiphinema spp., Longidorus spp., and Trichodorus spp.; semiparasites such as Tylenchulus spp.; migratory endoparasites such as Pratylenchus spp., Radopholus spp., and Scutellonema spp.; sedentary parasites such as Heterodera spp., Globodera spp., and Meloidogyne spp., and stem and leaf endoparasites such as Ditylenchus spp., Aphelenchoides spp., and Hirshmaniella spp. Especially harmful root parasitic soil nematodes are such as cystforming nematodes of the genera Heterodera or Globodera, and/or root knot nematodes of the genus Meloidogyne. Harmful species of these genera are for example Meloidogyne incognita, Heterodera glycines (soybean cyst nematode), Globodera pallida and Globodera rostochiensis (potato cyst nematode), which species are effectively controlled with the compounds described herein. However, the use of the compounds described herein is in no way restricted to these genera or species, but also extends in the same manner to other nematodes.

Plant nematodes include but are not limited to e.g. Aglenchus agricola, Anguina tritici, Aphelenchoides arachidis, Aphelenchoides fragaria and the stem and leaf endoparasites Aphelenchoides spp. in general, Belonolaimus gracilis, Belonolaimus longicaudatus, Belonolaimus nortoni, Bursaphelenchus cocophilus, Bursaphelenchus eremus, Bursaphelenchus xylophilus and Bursaphelenchus spp. in general, Cacopaurus pestis, Criconemella curvata, Criconemella onoensis, Criconemella ornata, Criconemella rusium, Criconemella xenoplax (=Mesocriconema xenoplax) and Criconemella spp. in general, Criconemoides femiae, Criconemoides onoense, Criconemoides ornatum and Criconemoides spp. in general, Ditylenchus destructor, Ditylenchus dipsaci, Ditylenchus myceliophagus and the stem and leaf endoparasites Ditylenchus spp. in general, Dolichodorus heterocephalus, Globodera pallida (=Heterodera pallida), Globodera rostochiensis (potato cyst nematode), Globodera solanacearum, Globodera tabacum, Globodera virginia and the sedentary, cyst forming parasites Globodera spp. in general, Helicotylenchus digonicus, Helicotylenchus dihystera, Helicotylenchus erythrine, Helicotylenchus multicinctus, Helicotylenchus nannus, Helicotylenchus pseudorobustus and Helicotylenchus spp. in general, Hemicriconemoides, Hemicycliophora arenaria, Hemicycliophora nudata, Hemicycliophora parvana, Heterodera avenae, Heterodera cruciferae, Heterodera glycines (soybean cyst nematode), Heterodera oryzae, Heterodera schachtii, Heterodera zeae and the sedentary, cyst forming parasites Heterodera spp. in general, Hirschmaniella gracilis, Hirschmaniella oryzae Hirschmaniella spinicaudata and the stem and leaf endoparasites Hirschmaniella spp. in general, Hoplolaimus aegyptii, Hoplolaimus califomicus, Hoplolaimus columbus, Hoplolaimus galeatus, Hoplolaimus indicus, Hoplolaimus magnistylus, Hoplolaimus pararobustus, Longidorus africanus, Longidorus breviannulatus, Longidorus elongatus, Longidorus laevicapitatus, Longidorus vineacola and the ectoparasites Longidorus spp. in general, Meloidogyne acronea, Meloidogyne africana, Meloidogyne arenaria, Meloidogyne arenaria thamesi, Meloidogyne artiella, Meloidogyne chitwoodi, Meloidogyne coffeicola, Meloidogyne ethiopica, Meloidogyne exigua, Meloidogyne fallax, Meloidogyne graminicola, Meloidogyne graminis, Meloidogyne hapla, Meloidogyne incognita, Meloidogyne incognita acrita, Meloidogyne javanica, Meloidogyne kikuyensis, Meloidogyne minor, Meloidogyne naasi, Meloidogyne paranaensis, Meloidogyne thamesi and the sedentary parasites Meloidogyne spp. in general, Meloinema spp., Nacobbus aberrans, Neotylenchus vigissi, Paraphelenchus pseudoparietinus, Paratrichodorus allius, Paratrichodorus lobatus, Paratrichodorus minor, Paratrichodorus nanus, Paratrichodorus porosus, Paratrichodorus teres and Paratrichodorus spp. in general, Paratylenchus hamatus, Paratylenchus minutus, Paratylenchus projectus and Paratylenchus spp. in general, Pratylenchus agilis, Pratylenchus alleni, Pratylenchus andinus, Pratylenchus brachyurus, Pratylenchus cerealis, Pratylenchus coffeae, Pratylenchus crenatus, Pratylenchus delattrei, Pratylenchus giibbicaudatus, Pratylenchus goodeyi, Pratylenchus hamatus, Pratylenchus hexincisus, Pratylenchus loosi, Pratylenchus neglectus, Pratylenchus penetrans, Pratylenchus pratensis, Pratylenchus scribneri, Pratylenchus teres, Pratylenchus thornei, Pratylenchus vulnus, Pratylenchus zeae and the migratory endoparasites Pratylenchus spp. in general, Pseudohalenchus minutus, Psilenchus magnidens, Psilenchus tumidus, Punctodera chalcoensis, Quinisulcius acutus, Radopholus citrophilus, Radopholus similis, the migratory endoparasites Radopholus spp. in general, Rotylenchulus borealis, Rotylenchulus parvus, Rotylenchulus reniformis and Rotylenchulus spp. in general, Rotylenchus laurentinus, Rotylenchus macrodoratus, Rotylenchus robustus, Rotylenchus uniformis and Rotylenchus spp. in general, Scutellonema brachyurum, Scutellonema bradys, Scutellonema clathricaudatum and the migratory endoparasites Scutellonema spp. in general, Subanguina radiciola, Tetylenchus nicotianae, Trichodorus cylindricus, Trichodorus minor, Trichodorus primitivus, Trichodorus proximus, Trichodorus similis, Trichodorus sparsus and the ectoparasites Trichodorus spp. in general, Tylenchorhynchus agri, Tylenchorhynchus brassicae, Tylenchorhynchus clarus, Tylenchorhynchus claytoni, Tylenchorhynchus digitatus, Tylenchorhynchus ebriensis, Tylenchorhynchus maximus, Tylenchorhynchus nudus, Tylenchorhynchus vulgaris and Tylenchorhynchus spp. in general, Tylenchulus semipenetrans and the semiparasites Tylenchulus spp. in general, Xiphinema americanum, Xiphinema brevicolle, Xiphinema dimorphicaudatum, Xiphinema index and the ectoparasites Xiphinema spp. in general.

Examples of nematodes to which a nematicide of the present invention is applicable include, but are not limited to, nematodes of the genus Meloidogyne such as the southern root-knot nematode (Meloidogyne incognita), Javanese root-knot nematode (Meloidogyne javanica), northern root-knot nematode (Meloidogyne hapla), and peanut root-knot nematode (Meloidogyne arenaria); nematodes of the genus Ditylenchus such as the potato rot nematode (Ditylenchus destructor) and bulb and stem nematode (Ditylenchus dipsaci); nematodes of the genus Pratylenchus such as the cob root-lesion nematode (Pratylenchus penetrans), chrysanthemum root-lesion nematode (Pratylenchus fallax), coffee root-lesion nematode (Pratylenchus coffeae), tea root-lesion nematode (Pratylenchus loosi), and walnut root-lesion nematode (Pratylenchus vulnus); nematodes of the genus Globodera such as the golden nematode (Globodera rostochiensis) and potato cyst nematode (Globodera pallida); nematodes of the genus Heterodera such as the soybean cyst nematode (Heterodera glycines) and sugar beet cyst nematode (Heterodera schachtii); nematodes of the genus Aphelenchoides such as the rice white-tip nematode (Aphelenchoides besseyi), chrysanthemum foliar nematode (Aphelenchoides ritzemabosi), and strawberry nematode (Aphelenchoides fragariae); nematodes of the genus Aphelenchus such as the mycophagous nematode (Aphelenchus avenae); nematodes of the genus Radopholus such as the burrowing nematode (Radopholus similis); nematodes of the genus Tylenchulus such as the citrus nematode (Tylenchulus semipenetrans); nematodes of the genus Rotylenchulus such as the reniform nematode (Rotylenchulus reniformis); nematodes that occur in trees, such as the pine wood nematode (Bursaphelenchus xylophilus), and the like.

The compound(s) and compositions comprising the compound(s) of the present invention is/are particularly useful in controlling nematodes in soybean belonging to at least one species selected from the group of the phytoparasitic nematodes, especially consisting of Pratylenchus brachyurus, Pratylenchus pratensis, Pratylenchus penetrans, Pratylenchus scribneri, Belonolaimus longicaudatus, Heterodera glycines, Hoplolaimus columbus and also consisting of Pratylenchus coffeae, Pratylenchus hexincisus, Pratylenchus neglectus, Pratylenchus crenatus, Pratylenchus alleni, Pratylenchus agilis, Pratylenchus zeae, Pratylenchus vulnus, (Belonolaimus gracilis), Meloidogyne arenaria, Meloidogyne incognita, Meloidogyne javanica, Meloidogyne hapla, Hoplolaimus columbus, Hoplolaimus galeatus, Rotylenchulus reniformis.

Moreover, insecticidal pests which can be combatted/controlled/treated by the treatment of Bt-soybeans with a ryanodine receptor modulator include:

pests from the phylum Arthropoda, especially from the class Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., Epitrimerus pyri, Eutetranychus spp., Eriophyes spp., Glycyphagus domesticus, Halotydeus destructor, Hemitarsonemus spp., Hyalomma spp., Ixodes spp., Latrodectus spp., Loxosceles spp., Metatetranychus spp., Neutrombicula autumnalis, Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., Tetranychus spp., Trombicula alfreddugesi, Vaejovis spp., Vasates lycopersici;
from the class Chilopoda, for example, Geophilus spp., Scutigera spp.;
from the order or the class Collembola, for example, Onychiurus armatus;
from the class Diplopoda, for example, Blaniulus guttulatus;
from the class Insecta, e.g. from the order Blattodea, for example, Blattella asahinai, Blattella germanica, Blatta orientalis, Leucophaea maderae, Panchlora spp., Parcoblatta spp., Periplaneta spp., Supella longipalpa;
from the order Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptolestes ferrugineus, Cryptorhynchus lapathi, Cylindrocopturus spp., Dermestes spp., Diabrotica spp., Dichocrocis spp., Dicladispa armigera, Diloboderus spp., Epilachna spp., Epitrix spp., Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., Lachnosterna consanguinea, Lasioderma serricorne, Latheticus oryzae, Lathridius spp., Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Necrobia spp., Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllophaga helleri, Phyllotreta spp., Popillia japonica, Premnotrypes spp., Prostephanus truncatus, Psylliodes spp., Ptinus spp., Rhizobius ventralis, Rhizopertha dominica, Sitophilus spp., Sitophilus oryzae, Sphenophorus spp., Stegobium paniceum, Sternechus spp., Symphyletes spp., Tanymecus spp., Tenebrio molitor, Tenebrioides mauretanicus, Tribolium spp., Trogoderma spp., Tychius spp., Xylotrechus spp., Zabrus spp.;
from the order Diptera, for example, Aedes spp., Agromyza spp., Anastrepha spp., Anopheles spp., Asphondylia spp., Bactrocera spp., Bibio hortulanus, Calliphora erythrocephala, Calliphora vicina, Ceratitis capitata, Chironomus spp., Chrysomyia spp., Chrysops spp., Chrysozona pluvialis, Cochliomyia spp., Contarinia spp., Cordylobia anthropophaga, Cricotopus sylvestris, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., Lucilia spp., Lutzomyia spp., Mansonia spp., Musca spp., Oestrus spp., Oscinella frit, Paratanytarsus spp., Paralauterborniella subcincta, Pegomyia spp., Phlebotomus spp., Phorbia spp., Phormia spp., Piophila casei, Prodiplosis spp., Psila rosae, Rhagoletis spp., Sarcophaga spp., Simulium spp., Stomoxys spp., Tabanus spp., Tetanops spp., Tipula spp.;
from the order Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptocorisa varicornis, Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.;
from the order Homoptera, for example, Acizzia acaciaebaileyanae, Acizzia dodonaeae, Acizzia uncatoides, Acrida turrita, Acyrthosipon spp., Acrogonia spp., Aeneolamia spp., Agonoscena spp., Aleyrodes proletella, Aleurolobus barodensis, Aleurothrixus floccosus, Allocaridara malayensis, Amrasca spp., Anuraphis cardui, Aonidiella spp., Aphanostigma pini, Aphis spp., Arboridia apicalis, Arytainilla spp., Aspidiella spp., Aspidiotus spp., Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., Calligypona marginata, Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus ficus, Cicadulina mbila, Coccomytilus halli, Coccus spp., Cryptomyzus ribis, Cryptoneossa spp., Ctenarytaina spp., Dalbulus spp., Dialeurodes citri, Diaphorina citri, Diaspis spp., Drosicha spp., Dysaphis spp., Dysmicoccus spp., Empoasca spp., Eriosoma spp., Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Macrosteles facifrons, Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nettigoniclla spectra, Nilaparvata lugens, Oncometopia spp., Orthezia praelonga, Oxya chinensis, Pachypsylla spp., Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Prosopidopsylla flava, Protopulvinaria pyriformis, Pseudaulacaspis pentagona, Pseudococcus spp., Psyllopsis spp., Psylla spp., Pteromalus spp., Pyrilla spp., Quadraspidiotus spp., Quesada gigas, Rastrococcus spp., Rhopalosiphum spp., Saissetia spp., Scaphoideus titanus, Schizaphis graminum, Selenaspidus articulatus, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., Trialeurodes vaporariorum, Trioza spp., Typhlocyba spp., Unaspis spp., Viteus vitifolii, Zygina spp.;
from the order Hymenoptera, for example, Acromyrmex spp., Athalia spp., Atta spp., Diprion spp., Hoplocampa spp., Lasius spp., Monomorium pharaonis, Sirex spp., Solenopsis invicta, Tapinoma spp., Urocerus spp., Vespa spp., Xeris spp.;
from the order Isopoda, for example, Armadillidium vulgare, Oniscus asellus, Porcellio scaber;
from the order Isoptera, for example, Coptotermes spp., Cornitermes cumulans, Cryptotermes spp., Incisitermes spp., Microtermes obesi, Odontotermes spp., Reticulitermes spp.;
from the order Lepidoptera, for example, Achroia grisella, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamstra brassicae, Melanitis leda, Mocis spp., Monopis obviella, Mythimna separata, Nemapogon cloacellus, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudaletia unipuncta, Pseudoplusia includens, Pyrausta nubilalis, Rachiplusia nu, Schoenobius spp., Scirpophaga spp., Scirpophaga innotata, Scotia segetum, Sesamia spp., Sesamia inferens, Sparganothis spp., Spodoptera spp., Spodoptera praefica, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., Tryporyza incertulas, Tuta absoluta, Virachola spp.;
from the order Orthoptera or Saltatoria, for example, Acheta domesticus, Dichroplus spp., Gryllotalpa spp., Hieroglyphus spp., Locusta spp., Melanoplus spp., Schistocerca gregaria;
from the order Phthiraptera, for example, Damalinia spp., Haematopinus spp., Linognathus spp., Pediculus spp., Ptirus pubis, Trichodectes spp.;
from the order Psocoptera for example Lepinatus spp., Liposcelis spp.;
from the order Siphonaptera, for example, Ceratophyllus spp., Ctenocephalides spp., Pulex irritans, Tunga penetrans, Xenopsylla cheopsis;
from the order Thysanoptera, for example, Anaphothrips obscurus, Baliothrips biformis, Drepanothrips reuteri, Enneothrips flavens, Frankliniella spp., Heliothrips spp., Hercinothrips femoralis, Rhipiphorothrips cruentatus, Scirtothrips spp., Taeniothrips cardamomi, Thrips spp.;
from the order Zygentoma (=Thysanura), for example, Ctenolepisma spp., Lepisma saccharina, Lepismodes inquilinus, Thermobia domestica;
from the class Symphyla, for example, Scutigerella spp.;

pests from the phylum Mollusca, especially from the class Bivalvia, for example, Dreissena spp., and from the class Gastropoda, for example, Anion spp., Biomphalaria spp., Bulinus spp., Deroceras spp., Galba spp., Lymnaea spp., Oncomelania spp., Pomacea spp., Succinea spp.;

It is furthermore possible to control organisms from the subphylum Protozoa, especially from the order Coccidia, such as Eimeria spp.

In one preferred embodiment, pests to be controlled/combatted/treated are selected from the group consisting of Pseudoplusia includens (soybean looper), Anticarsia gemmatalis (velvet bean caterpillar) and Spodoptera frugiperda (fall armyworm).

In an advantageous embodiment, the ryanodine receptor modulator as described herein are used for treating transgenic soybean plants comprising at least one gene or gene fragment coding for a Bt toxin. A Bt toxin is a protein originating from or derived from the soil bacterium Bacillus thuringiensis which either belongs to the group of the crystal toxins (Ciy) or the cytolytic toxins (Cyt). In the bacterium, they are originally formed as protoxins and are only metabolized in alkaline medium—for example in the digestive tract of certain feed insects—to their active form. There, the active toxin then binds to certain hydrocarbon structures at cell surfaces causing pores to be formed which destroy the osmotic potential of the cell, which may effect cell lysis. The result is the death of the insects. Bt toxins are active in particular against certain harmful species from the orders of the Lepidoptera (butterflies), Homoptera, Diptera and Coleoptera (beetles) in all their development stages; i.e. from the egg larva via their juvenile forms to their adult forms.

It has been known for a long time that gene sequences coding for Bt toxins, parts thereof or else peptides or proteins derived from Bt toxins can be cloned with the aid of genetic engineering into agriculturally useful plants to generate transgenic plants having endogenous resistance to pests sensitive to Bt toxins. For the purpose of the invention, the transgenic plants coding for at least one Bt toxin or proteins derived therefrom are defined as “Bt plants”.

The “first generation” of such Bt plants generally only comprise the genes enabling the formation of a certain toxin, thus only providing resistance to one group of pathogens. An example of a commercially available maize variety comprising the gene for forming the Cry1Ab toxin is “YieldGard®” from Monsanto which is resistant to the European corn borer. In contrast, in the Bt cotton variety (Bollgard®), resistance to other pathogens from the family of the Lepidoptera is generated by introduction by cloning of the genes for forming the Cry1Ac toxin. Other transgenic crop plants, in turn, express genes for forming Bt toxins with activity against pathogens from the order of the Coleoptera. Examples that may be mentioned are the Bt potato variety “NewLeaf®” (Monsanto) capable of forming the Cry3A toxin, which is thus resistant to the Colorado potato beetle, and the transgenic maize variety “YieldGard®” (Monsanto) which is capable of forming the Cry 3Bb1 toxin and is thus protected against various species of the Western corn rootworm.

In a “second generation”, the multiply transgenic plants, already described above, expressing or comprising at least two foreign genes were generated, e.g. INTACTA RR2 Pro™.

Preference according to the invention is given to transgenic plants with Bt toxins from the group of the Cry family (see, for example, Crickmore et al., 1998, Microbiol. Mol. Biol. Rev. 62: 807-812), which are particularly effective against Lepidoptera, Coleoptera and Diptera. Examples of genes coding for the proteins are:

Cry1A, cry1Aa1, cry1Aa2, cry1Aa3, cry1Aa4, cry1Aa5, cry1Aa6, cry1Aa7, cry1Aa8, cry1Aa9, cry1Aa10, cry1Aa11cry1Ab1, cry1Ab2, cry1Ab3, cry1Ab4, cry1Ab5, cry1Ab6, cry1Ab7, cry1Ab8, cry1Ab9, cry1Ab10, cry1Ab11, cry1Ab12, cry1Ab13, cry1Ab14, cry1Ac1, cry1Ac2, cry1Ac3, cry1Ac4, cry1Ac5, cry1Ac6, cry1Ac7, cry1Ac8, cry1Ac9, cry1Ac10, cry1Ac11, cry1Ac12, cry1Ac13, cry1Ad1, cry1Ad2, cry1Ae1, cry1Af1, cry1Ag1, cry1B, cry1Ba1, cry1Ba2, cry1Bb1, cry1Bc1, cry1Bd1, cry1Be1, cry1C, cry1Ca1, cry1Ca2, cry1Ca3, cry1Ca4, cry1Ca5, cry1Ca6, cry1Ca7, cry1Cb1, cry1Cb2, cry1D, cry1Da1, cry1Da2, cry1Db1, cry1E, cry1Ea1, cry1Ea2, cry1Ea3, cry1Ea4, cry1Ea5, cry1Ea6, cry1Eb1, cry1F, cry1Fa1, cry1Fa2, cry1Fb1, cry1Fb2, cry1Fb3, cry1Fb4, cry1G, cry1Ga1, cry1Ga2, cry1Gb1, cry1Gb2, cry1H, cry1Ha1, cry1Hb1, cry1I, cry1Ia1, cry1Ia2, cry1Ia3, cry1Ia4, cry1Ia5, cry1Ia6, cry1Ib1, cry1Ic1, cry1Id1, cry1Ie1, cry1I-like, cry1J, cry1Ja1, cry1Jb1, cry1Jc1, cry1Ka1, cry1-like, cry2A, cry2Aa1, cry2Aa2, cry2Aa3, cry2Aa4, cry2Aa5, cry2Aa6, cry2Aa7, cry2Aa8, cry2Aa9, cry2Ab1, cry2Ab2, cry2Ab3, cry2Ac1, cry2Ac2, cry2Ad1, cry3A, cry3Aa1, cry3Aa2, cry3Aa3, cry3Aa4, cry3Aa5, cry3Aa6, cry3Aa7, cry3B, cry3Ba1, cry3Ba2, cry3Bb1, cry3Bb2, cry3Bb3, cry3Ca1, cry4Aa1, cry4Aa2, cry4Ba1, cry4Ba2, cry4Ba3, cry4Ba4, cry5Aa1, cry5Ab1, cry5Ac1, cry5Ba1, cry6Aa1, cry6Ba1, cry7Aa1, cry7Ab1, cry7Ab2, cry8Aa1, cry10Aa1, cry8Ca1, cry9Aa1, cry9Aa2, cry9Ba1, cry9Ca1, cry9Da1, cry9Da2, cry9Ea1, cry9 like, cry10Aa1, cry10Aa2, cry11Aa1, cry11Aa2, cry11Ba1, cry11Bb1, cry12Aa1, cry13Aa1, cry14Aa1, cry15Aa1, cry16Aa1, cry17Aa1, cry18Aa1, cry18Ba1, cry18Ca1, cry19Aa1, cry19Ba1, cry20Aa1, cry21Aa1, cry21Aa2, cry22Aa1, cry23Aa1, cry24Aa1, cry25Aa1, cry26Aa1, cry27Aa1, cry28Aa1, cry28Aa2, cry29Aa1, cry30Aa1, cry31Aa1, cry34, cry35, cyt1Aa1, cyt1Aa2, cyt1Aa3, cyt1Aa4, cyt1Ab1, cyt1Ba1, cyt2Aa1, cyt2Ba1, cyt2Ba2, cyt2Ba3, cyt2Ba4, cyt2Ba5, cyt2Ba6, cyt2Ba7, cyt2Ba8, cyt2Bb1, VIP3A.

Particular preference is given to the genes or gene sections of the subfamilies cry1, cry2, cry3, cry5 and cry9; especially preferred are cry1Ab, cry1Ac, cry2Ab, cry1F.

Furthermore, it is preferred to use plants which, in addition to the genes for one or more Bt toxins, express or contain, if appropriate, also genes for expressing, for example, a protease or peptidase inhibitor (such as in WO-A 95/35031), of herbicide resistances (for example to glufosinate or glyphosate by expression of the pat gene or bar gene) or for becoming resistant to nematodes, fungi or viruses (for example by expressing a gluconase, chitinase). However, they may also be genetically modified in their metabolic properties, so that they show a qualitative and/or quantitative change of ingredients (for example by modification of the energy, carbohydrate, fatty acid or nitrogen metabolism or by metabolite currents influencing these (see above).

In one preferred embodiment, a Bt-soybean comprises event MON87701 which is described in, e.g., WO2009/064652. Thus, in one preferred embodiment, a Bt-soybean seeds of which comprising said event were deposited at the ATCC under Accession No. PTA-8194 are treated with a ryanodine receptor modulator according to the present invention. In a more preferred embodiment, said Bt-soybean plant comprises event MON87701 and event MON89788, e.g. Intacta™ Roundup Ready™ 2 Pro.

In another preferred embodiment, a Bt-soybean comprises event pDAB9582.814.19.1 and/or event pDAB4468.04.16.1 which are described in, e.g., WO 2013/016516. This breeding stacks comprise cry1F, cry1Ac and pat and aad-12 and pat, as described in WO 2012/075426. Thus, in one preferred embodiment, a Bt-soybean seeds of which comprising said events were deposited at the ATCC under Accession No. PTA-10442 (pDAB4468.04.16.1) are treated with a ryanodine receptor modulator according to the present invention.

The ryanodine receptor modulators which can be used according to the invention can be employed in customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active compound, synthetic substances impregnated with active compound, fertilizers and also microencapsulations in polymeric substances.

These formulations are prepared in a known manner, for example by mixing the active compounds with extenders, i.e. liquid solvents and/or solid carriers, if appropriate using surfactants, i.e. emulsifiers and/or dispersants and/or foam-formers. The formulations are prepared either in suitable plants or else before or during application.

Wettable powders are preparations which can be dispersed homogeneously in water and which, in addition to the active compound and beside a diluent or inert substance, also comprise wetting agents, for example polyethoxylated alkylphenols, polyethoxylated fatty alcohols, alkylsulphonates or alkylphenylsulphonates and dispersants, for example sodium lignosulphonate, sodium 2,2′-dinaphthylmethane-6,6′-disulphonate.

Dusts are obtained by grinding the active compound with finely distributed solid substances, for example talc, natural clays, such as kaolin, bentonite, pyrophillite or diatomaceous earth. Granules can be prepared either by spraying the active compound onto granular inert material capable of adsorption or by applying active compound concentrates to the surface of carrier substances, such as sand, kaolinites or granular inert material, by means of adhesives, for example polyvinyl alcohol, sodium polyacrylate or mineral oils. Suitable active compounds can also be granulated in the manner customary for the preparation of fertilizer granules—if desired as a mixture with fertilizers.

Suitable for use as auxiliaries are substances which are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

Suitable solid carriers are for example, ammonium salts and ground natural minerals such as kaolins, clays, talc, chalk, quartz, attapulgite, montmorillonite or diatomaceous earth, and ground synthetic minerals, such as finely divided silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

Other possible additives are perfumes, mineral or vegetable, optionally modified oils, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present.

These individual types of formulation are known in principle and are described, for example, in: “Pesticides Formulations”, 2nd Ed., Marcel Dekker N.Y.; Martens, 1979, “Spray Drying Handbook”, 3rd Ed., G. Goodwin Ltd. London.

Based on his general expert knowledge, the person skilled in the art is able to choose suitable formulation auxiliaries (in this context, see, for example, Watkins, “Handbook of Insecticide Dust Diluents and Carriers”, 2nd Ed., Darland Books, Caldwell N.J.).

In general, the formulations comprise from 0.01 to 98% by weight of active compound, preferably from 0.5 to 90%. In wettable powders, the active compound concentration is, for example, from about 10 to 90% by weight, the remainder to 100% by weight consisting of customary formulation components. In the case of emulsifiable concentrates, the active compound concentration can be from about 5 to 80% by weight. In most cases, formulations in the form of dusts comprise from 5 to 20% by weight of active compound, sprayable solutions comprise about 2 to 20% by weight. In the case of granules, the active compound content depends partially on whether the active compound is present in liquid or solid form and on which granulation auxiliaries, fillers, etc., are used.

In a preferred embodiment, the Bt-soybean plants or plant parts are treated according to the invention with a SC (suspension concentrate) formulation. For example, the ryanodine receptor modulator in such a formulation is flubendiamide (Belt), chlorantraniliprole (Rynaxypyr).

In a preferred embodiment, the SC formulation comprises between 5 g/1 and 800 g/l, such as 240 g/l or 480 g/l ryanodine receptor modulator.

In another preferred embodiment, the Bt-soybean plants or plant parts are treated according to the invention with a OD (oil dispersion) formulation. For example, the ryanodine receptor modulator in such a formulation is cyantraniliprole [Cyazypyr).

In a preferred embodiment, the OD formulation comprises between 5 g/1 and 800 g/l, such as 10 g/l or 100 g/l ryanodine receptor modulator.

The required application rate may also vary with external conditions such as, inter alia, temperature and humidity. It may vary within wide limits, for example between 0.1 g/ha and 5.0 kg/ha or more of active substance. However, they are preferably between 0.1 g/ha and 1.0 kg/ha. Owing to the synergistic effects between Bt vegetables and the insecticide, particular preference is given to application rates of from 0.1 to 500 g/ha.

In one preferred embodiment, the application rates of a ryanodine receptor modulator are from 0.5 to 100 g/ha such as from 5 to 100 g/ha or from 5 to 50 g/ha.

In their commercial formulations and in the use forms prepared from these formulations, the active compounds according to the invention may be present as mixtures with other active compounds, such as insecticides, attractants, sterilants, acaricides, nematicides, fungicides, growth-regulating substances or herbicides.

A mixture with other known compounds, such as herbicides, fertilizers, growth regulators, safeners, semiochemicals, or else with agents for improving plant properties is also possible.

The active compound content of the use forms prepared from the commercial formulations can be from 0.00000001 to 95% by weight, preferably between 0.00001 and 1% by weight, of active compound.

One aspect of the present invention refers to a synergistic combination of a ryanodine receptor modulator as described herein and a Bt-toxin. Such a combination can be in form of a formulation or in form of a sufficient amount of a ryanodine receptor modulator attached to a Bt-soybean plant or plant part thereof. The amount of ryanodine receptor modulator on or in a Bt-soybean plant or plant parts thereof and the amount of Bt-toxin in a Bt-soybean plant or plant parts thereof can be determined by standard procedures known in the art (see, e.g., “Xiaojun Chen et al. “Determination of Residual Flubendiamide in the Cabbage by QuEChERS-Liquid Chromatography-Tandem Mass Spectrometry” Bulletin of Environmental Contamination and Toxicology, November 2012, Volume 89, Issue 5, pp 1021-1026″ and “H. T. Nguyen and A Jehle “Quantitative analysis of the seasonal and tissue-specific expression of Cry1Ab in transgenic maize Mon180, J. of Plant Diseases and Protection, 114(2), 82-87, 2007, ISSN 1861-3829, Eugen Ulmer Stuttgart”).

Another aspect of the present invention refers to a Bt-soybean plant to which an amount of a ryanodine receptor modulator as described herein is attached and/or in which an amount of a ryanodine receptor modulator as described herein is introduced characterized in that the amount of ryanodine receptor modulator as described herein is at least 0.0000001 g, preferably at least 0.000001 g or even at least 0.00001 g. Such values of a ryanodine receptor modulator can be reached for example by spraying a hectare of culture soybean plants with a OD 10, SC240, or SC480 formulation according to well-known standard spray programs.

### EXPERIMENT

### Spodoptera frugiperda—Spray Application on Transgenic Soybean, Field Trial

For preparing the stock solution, 20 mg of active compound is solved in 200 μl of dimethylformamide and filled-up with 9.78 ml SC blank formulation of Belt. The final test concentrations are prepared by dilution with water.

The test is conducted with conventional soybean plants (Glycine max) and transgenic soybean plants containing a hybrid of Cry1Ac and Cry1Ab (Intacta from Monsanto). When the plants are in stage V2 (3 nodes with 2 unfolded trifoliolates), they are treated by spray application with the active compound preparation. After application, clip-cages with 5-6 L2 larvae of the fall army worm (Spodoptera frugiperda) are placed on the leaves.

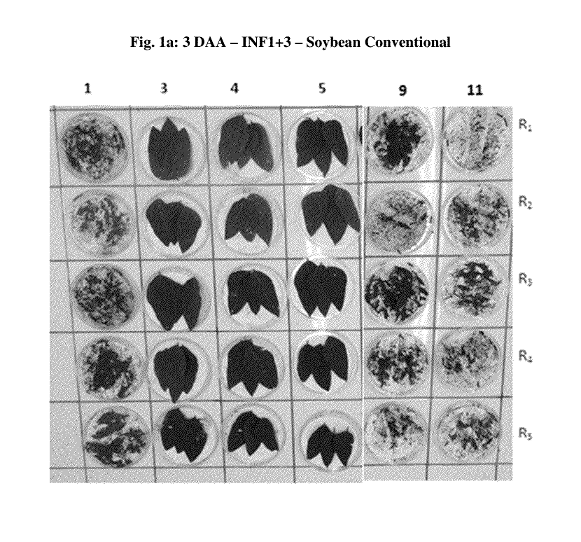

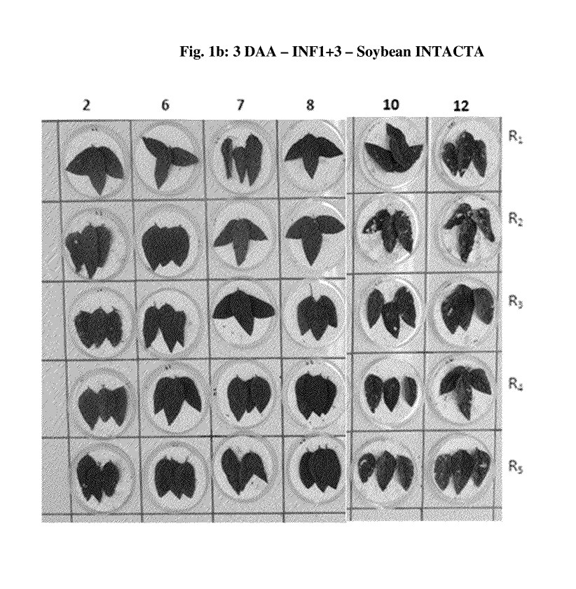

After the specified period of time, feeding damage (white holes on leaves) of Spodoptera frugiperda on conventional soybean, FIG. 1a, in comparison to Intacta soybean, FIG. 1b, is visualized on 3 randomly picked soybean leaves out of 5 replicate plots (R₁-R₅).

According to the present application in this test the following combinations of transgenic plant and compound shows a superior effect compared to the treated, non-transgenic plant respectively the non-treated, transgenic plant:

TABLE A
3 days after application (3 DAA)
Infection 1 + 3 days (Inf 1 + 3)
5 replicates per variety

| | Compound | Conc. [g ai/ha] | Soy variety |
|---|---|---|---|
| 1 | Untreated control | | Conventional |
| 2 | Untreated control | | Intacta |
| 3 | Flubendiamide | 12 | Conventional |
| 4 | Flubendiamide | 24 | Conventional |
| 5 | Flubendiamide | 36 | Conventional |
| 6 | Flubendiamide | 12 | Intacta |
| 7 | Flubendiamide | 24 | Intacta |
| 8 | Flubendiamide | 36 | Intacta |
| 9 | SC blank formulation | 0 | Conventional |
| 10 | SC blank formulation | 0 | Intacta |
| 11 | Water | 0 | Conventional |
| 12 | Water | 0 | Intacta |

Results of the experiments 1 to 12 of Table A are shown in FIGS. 1a and 1b

1. Method for controlling one or more pests, comprising treating a Bt-soybean plant with an effective amount of at least one ryanodine receptor modulator selected from the group consisting of 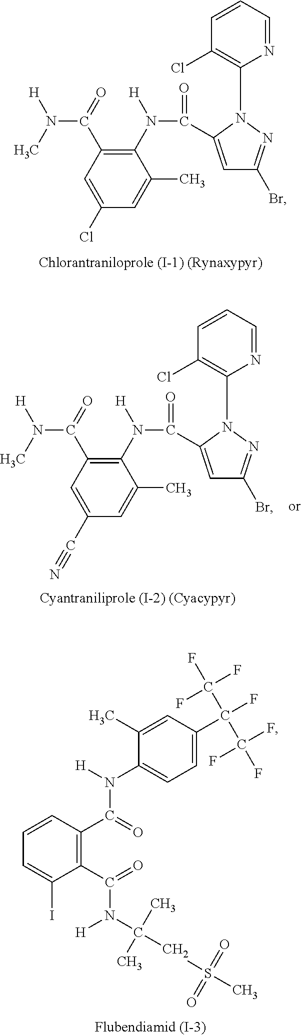 [SMILES: CNC(=O)c1cc(Cl)cc(C)c1NC(=O)c1cc(Br)nn1-c1ncccc1Cl ; CNC(=O)c1cc(C#N)cc(C)c1NC(=O)c1cc(Br)nn1-c1ncccc1Cl ; "or" ; Cc1cc(C(F)(C(F)(F)F)C(F)(F)F)ccc1NC(=O)c1cccc(I)c1C(=O)NC(C)(C)CS(C)(=O)=O]
or diamide compound (I-4) which can be (I-4-a) or a regioisomeric mixture of (I-4-a) and (I-4-b)

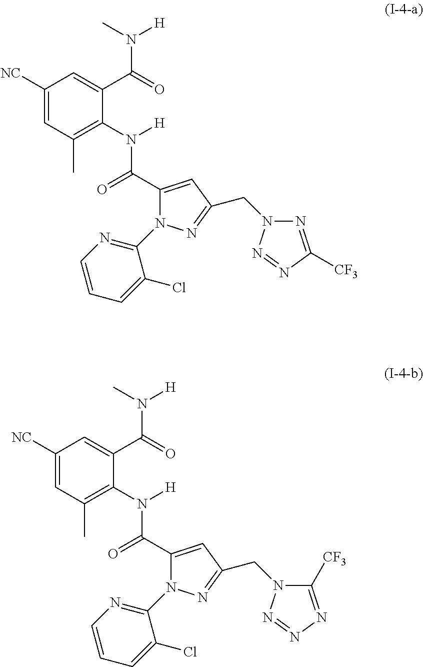 [SMILES: CNC(=O)c1cc(C#N)cc(C)c1NC(=O)c1cc(Cn2nnc(C(F)(F)F)n2)nn1-c1ncccc1Cl ; CNC(=O)c1cc(C#N)cc(C)c1NC(=O)c1cc(Cn2nnnc2C(F)(F)F)nn1-c1ncccc1Cl]

2. Method according to claim 1, wherein the Bt-soybean plant comprises at least one cry1A-gene or cry1A-gene fragment coding for a Bt toxin.

3. Method according to claim 1 further comprising a cryF gene or cryF-gene fragment coding for a Bt toxin.

4. Method according to claim 1, wherein the Bt-soybean plant comprises event MON87701 and event MON89788.

5. Method according to claim 1, wherein said soybean plant comprises DNA that comprises a first sequence selected from the group consisting of bp 1385-1415 of SEQ ID NO: 1; bp 1350-1450 of SEQ ID NO: 1; bp 1300-1500 of SEQ ID NO: 1; bp 1200-1600 of SEQ ID NO: 1; bp 137-168 of SEQ ID NO:2; bp 103-203 of SEQ ID NO:2; and bp 3-303 of SEQ ID NO:2; and a second sequence selected from the group consisting bp 2680-2780 of SEQ ID NO: 3; bp 2630-2830 of SEQ ID NO: 3; bp 2530-2930 of SEQ ID NO: 3; bp 9071-9171 of SEQ ID NO: 3; bp 9021-9221 of SEQ ID NO: 3; and, bp 8921-9321 of SEQ ID NO: 3 said first and second sequences being diagnostic for the presence of soybean event pDAB9582.814.19.1 pDAB4468.04.16.1.

6. Method according to claim 1, wherein said soybean plant comprises a nucleotide sequence of SEQ ID NO: 4, SEQ ID NO:5, or complement thereof.

7. Method according to claim 6, wherein the plant comprises a nucleotide sequence of SEQ ID NO:6, SEQ ID NO:7, SEQ ID NO:9 or complement thereof.

8. Method according to claim 6, wherein the plant comprises a nucleotide sequence of SEQ ID NO:6 from positions 1 to 5757, the nucleotide sequence of SEQ ID NO:8 from positions 1 to 6426, and the nucleotide sequence of SEQ ID NO:7 from positions 379 to 2611, or complement thereof.

9. Method according to claim 6, wherein the plant comprises a nucleotide sequence essentially of the nucleotide sequence of SEQ ID NO: 9 or complement thereof.

10. The method according to claim 1 wherein said one or more pests comprise Pseudoplusia includens (soybean looper), Anticarsia gemmatalis (velvet bean caterpillar), Spodoptera frugiperda (fall armyworm) or Helicoverpa spp (corn earworm).

11. Method according to claim 1, wherein said ryanodine receptor modulator is present in a mixture with at least one mixing partner.

12. Synergistic composition comprising a Bt toxin encoded by a nucleotide sequence that comprises
a first sequence selected from the group consisting of bp 1385-1415 of SEQ ID NO: 1; bp 1350-1450 of SEQ ID NO: 1; bp 1300-1500 of SEQ ID NO: 1; bp 1200-1600 of SEQ ID NO: 1; bp 137-168 of SEQ ID NO:2; bp 103-203 of SEQ ID NO:2; and bp 3-303 of SEQ ID NO:2; and a second sequence selected from the group consisting bp 2680-2780 of SEQ ID NO: 3; bp 2630-2830 of SEQ ID NO: 3; bp 2530-2930 of SEQ ID NO: 3; bp 9071-9171 of SEQ ID NO: 3; bp 9021-9221 of SEQ ID NO: 3; and, bp 8921-9321 of SEQ ID NO: 3 or
a nucleotide sequence of SEQ ID NO: 4, SEQ ID NO:5, or complement thereof

13. and a ryanodine receptor modulator selected from the group consisting of 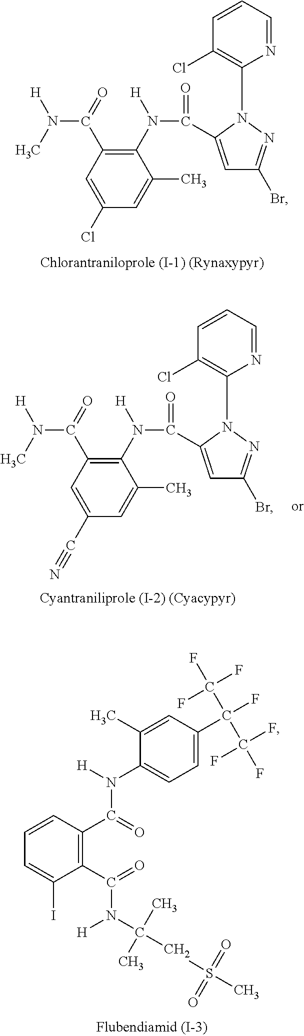 [SMILES: CNC(=O)c1cc(Cl)cc(C)c1NC(=O)c1cc(Br)nn1-c1ncccc1Cl ; CNC(=O)c1cc(C#N)cc(C)c1NC(=O)c1cc(Br)nn1-c1ncccc1Cl ; "or" ; Cc1cc(C(F)(C(F)(F)F)C(F)(F)F)ccc1NC(=O)c1cccc(I)c1C(=O)NC(C)(C)CS(C)(=O)=O]
or
diamide compound (I-4) which can be (I-4-a) or a regioisomeric mixture of (I-4-a) and (I-4-b)

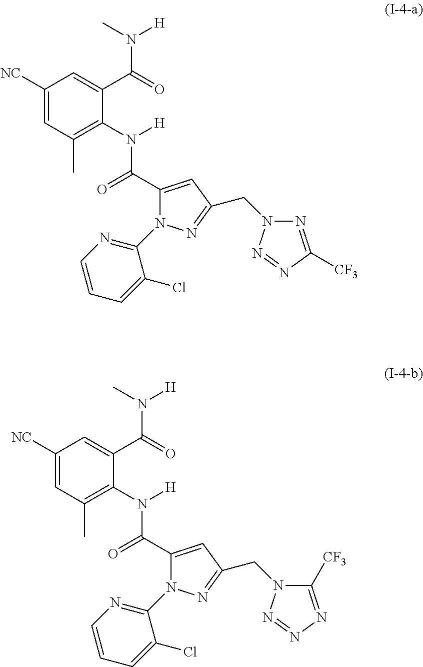 [SMILES: CNC(=O)c1cc(C#N)cc(C)c1NC(=O)c1cc(Cn2nnc(C(F)(F)F)n2)nn1-c1ncccc1Cl ; CNC(=O)c1cc(C#N)cc(C)c1NC(=O)c1cc(Cn2nnnc2C(F)(F)F)nn1-c1ncccc1Cl]

14. A Bt-soybean plant, wherein at least 0.00001 g of a ryanodine receptor modulator selected from the group consisting of 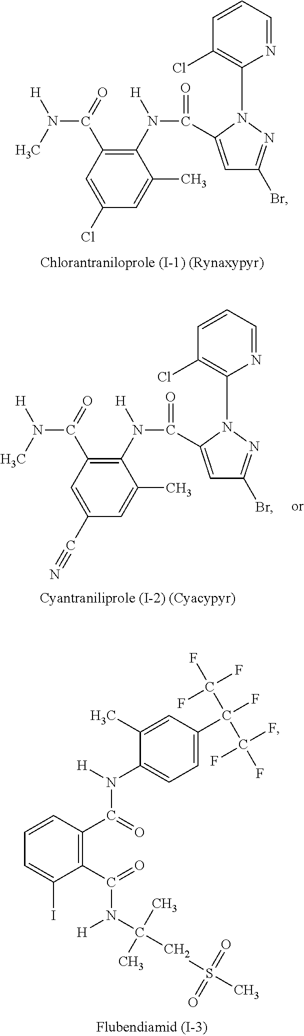 [SMILES: CNC(=O)c1cc(Cl)cc(C)c1NC(=O)c1cc(Br)nn1-c1ncccc1Cl ; CNC(=O)c1cc(C#N)cc(C)c1NC(=O)c1cc(Br)nn1-c1ncccc1Cl ; "or" ; Cc1cc(C(F)(C(F)(F)F)C(F)(F)F)ccc1NC(=O)c1cccc(I)c1C(=O)NC(C)(C)CS(C)(=O)=O]
or
diamide compound (I-4) which can be (I-4-a) or a regioisomeric mixture of (I-4-a) and (I-4-b) 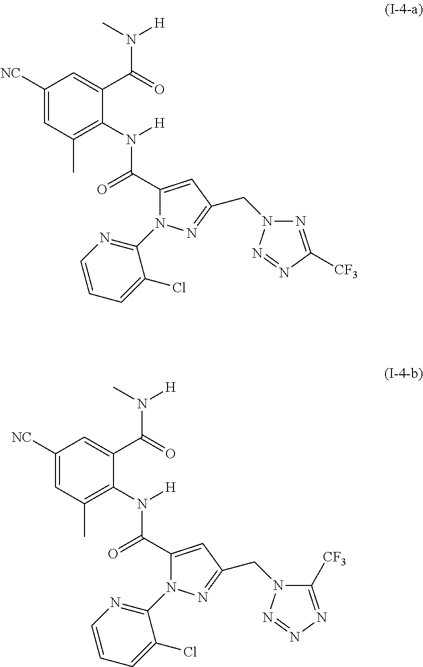 [SMILES: CNC(=O)c1cc(C#N)cc(C)c1NC(=O)c1cc(Cn2nnc(C(F)(F)F)n2)nn1-c1ncccc1Cl ; CNC(=O)c1cc(C#N)cc(C)c1NC(=O)c1cc(Cn2nnnc2C(F)(F)F)nn1-c1ncccc1Cl]
is attached to said plant.
